(19) United States
(12) Patent Application Publication
(10) Pub. No.: US 2025/0211312 A1
(43) Pub. Date: Jun. 26, 2025

(54) MACHINE LEARNING BASED PREDICTIVE INITIAL BEAM PAIRING FOR SIDELINK

(71) Applicant: QUALCOMM Incorporated, San Diego, CA (US)

(72) Inventors: Qiaoyu LI, Beijing (CN); Sony AKKARAKARAN, Poway, CA (US); Mahmoud TAHERZADEH BOROUJENI, San Diego, CA (US); Tao LUO, San Diego, CA (US)

(21) Appl. No.: 18/847,986

(22) PCT Filed: Jun. 3, 2022
(86) PCT No.: PCT/CN2022/097021

§ 371 Date: Sep. 17, 2024

(51) Int. Cl. H04B 7/06; H04L 5/00

(52) U.S. Cl. CPC H04B 7/06954; H04L 5/0053

(57) ABSTRACT

Methods, systems, and devices for wireless communications are described herein. A network entity and at least a first user equipment (UE) may support a signaling mechanism that enables the first UE to predict one or more directional beams for sidelink communication between the first UE and a second UE in accordance with sidelink information associated with one or both of the first UE and the second UE. The network entity may transmit the sidelink information to the first UE and the first UE may use the sidelink information to predict a set of one or more directional beams. The first UE may use the set of one or more directional beams to transmit or receive one or more sidelink synchronization signal blocks (SSBs) to or from the second UE or to transmit or receive a sidelink data message to or from the second UE.

### CROSS REFERENCE

The present Application is a 371 national phase filing of International PCT Application No. PCT/CN2022/097021 by LI et al., entitled “MACHINE LEARNING BASED PREDICTIVE INITIAL BEAM PAIRING FOR SIDELINK,” filed Jun. 3, 2022, which is assigned to the assignee hereof, and which is expressly incorporated by reference in its entirety herein.

### FIELD OF TECHNOLOGY

The following relates to wireless communications, including machine learning based predictive initial beam pairing for sidelink.

### BACKGROUND

Wireless communications systems are widely deployed to provide various types of communication content such as voice, video, packet data, messaging, broadcast, and so on. These systems may be capable of supporting communication with multiple users by sharing the available system resources (e.g., time, frequency, and power). Examples of such multiple-access systems include fourth generation (4G) systems such as Long Term Evolution (LTE) systems, LTE-Advanced (LTE-A) systems, or LTE-A Pro systems, and fifth generation (5G) systems which may be referred to as New Radio (NR) systems. These systems may employ technologies such as code division multiple access (CDMA), time division multiple access (TDMA), frequency division multiple access (FDMA), orthogonal FDMA (OFDMA), or discrete Fourier transform spread orthogonal frequency division multiplexing (DFT-S-OFDM). A wireless multiple-access communications system may include one or more base stations, each supporting wireless communication for communication devices, which may be known as user equipment (UE).

### SUMMARY

The described techniques relate to improved methods, systems, devices, and apparatuses that support machine learning based predictive initial beam pairing for sidelink. For example, the described techniques provide for predictions of one or more transmit beams or one or more receive beams, or any combination thereof, that a first user equipment (UE) may use for communicating (e.g., transmitting or receiving) with a second UE. In some implementations, the first UE may receive first sidelink information from a network entity, use the first sidelink information to predict a set of transmit beams associated with a set of sidelink synchronization signal blocks (SSBs), and transmit the set of sidelink SSBs to the second UE using the predicted set of transmit beams. Additionally, or alternatively, the first UE may use the first sidelink information to predict a set of receive beams associated with a set of sidelink SSBs and receive the set of sidelink SSBs using the predicted set of receive beams. Further, in some implementations, the first UE may receive second sidelink information from a network entity and may use the second sidelink information to predict a directional beam (e.g., a transmit beam or a receive beam, or both) associated with a sidelink data message. In such implementations, the first UE may communicate the sidelink data message with the second UE using the directional beam.

A method for wireless communication at a first UE is described. The method may include receiving, from a network entity, first sidelink information associated with the first UE, a second UE, or both, predicting, by the first UE based on the first sidelink information, a set of transmit beams and a set of transmit beam repetition patterns associated with a set of sidelink SSBs, and transmitting, to the second UE, the set of sidelink SSBs based on the set of transmit beams and the set of transmit beam repetition patterns.

An apparatus for wireless communication at a first UE is described. The apparatus may include a processor, memory coupled with the processor, and instructions stored in the memory. The instructions may be executable by the processor to cause the apparatus to receive, from a network entity, first sidelink information associated with the first UE, a second UE, or both, predict, by the first UE based on the first sidelink information, a set of transmit beams and a set of transmit beam repetition patterns associated with a set of sidelink SSBs, and transmit, to the second UE, the set of sidelink SSBs based on the set of transmit beams and the set of transmit beam repetition patterns.

Another apparatus for wireless communication at a first UE is described. The apparatus may include means for receiving, from a network entity, first sidelink information associated with the first UE, a second UE, or both, means for predicting, by the first UE based on the first sidelink information, a set of transmit beams and a set of transmit beam repetition patterns associated with a set of sidelink SSBs, and means for transmitting, to the second UE, the set of sidelink SSBs based on the set of transmit beams and the set of transmit beam repetition patterns.

A non-transitory computer-readable medium storing code for wireless communication at a first UE is described. The code may include instructions executable by a processor to receive, from a network entity, first sidelink information associated with the first UE, a second UE, or both, predict, by the first UE based on the first sidelink information, a set of transmit beams and a set of transmit beam repetition patterns associated with a set of sidelink SSBs, and transmit, to the second UE, the set of sidelink SSBs based on the set of transmit beams and the set of transmit beam repetition patterns.

In some examples of the method, apparatuses, and non-transitory computer-readable medium described herein, predicting the set of transmit beams and the set of transmit beam repetition patterns associated with a set of sidelink SSBs may include operations, features, means, or instructions for inputting the first sidelink information into a model configured to predict one or more transmission characteristics associated with the set of sidelink SSBs and obtaining, from the model, the set of transmit beams and the set of transmit beam repetition patterns.

Some examples of the method, apparatuses, and non-transitory computer-readable medium described herein may further include operations, features, means, or instructions for transmitting, to the network entity, an indication of the set of transmit beams and the set of transmit beam repetition patterns.

In some examples of the method, apparatuses, and non-transitory computer-readable medium described herein, transmitting the indication of the set of transmit beams and the set of transmit beam repetition patterns may include operations, features, means, or instructions for transmitting an identifier associated with the set of transmit beams and the set of transmit beam repetition patterns, where respective pairings of different sets of transmit beams and different sets of transmit beam repetition patterns may be associated with a respective identifier of a set of identifiers.

Some examples of the method, apparatuses, and non-transitory computer-readable medium described herein may further include operations, features, means, or instructions for receiving, from the network entity, a request for the indication of the set of transmit beams and the set of transmit beam repetition patterns, where transmitting the indication of the set of transmit beams and the set of transmit beam repetition patterns may be based on receiving the request.

Some examples of the method, apparatuses, and non-transitory computer-readable medium described herein may further include operations, features, means, or instructions for transmitting, to the network entity, a request to report the indication of the set of transmit beams and the set of transmit beam repetition patterns, where receiving the request for the indication of the set of transmit beams and the set of transmit beam repetition patterns may be based on transmitting the request to report the indication of the set of transmit beams and the set of transmit beam repetition patterns.

Some examples of the method, apparatuses, and non-transitory computer-readable medium described herein may further include operations, features, means, or instructions for receiving, from the network entity, a confirmation of the set of transmit beams and the set of transmit beam repetition patterns, where transmitting the set of sidelink SSBs includes transmitting the set of sidelink SSBs in accordance with the set of transmit beams and the set of transmit beam repetition patterns.

Some examples of the method, apparatuses, and non-transitory computer-readable medium described herein may further include operations, features, means, or instructions for receiving, from the network entity, an indication of an alternative set of transmit beams and an alternative set of transmit beam repetition patterns, where transmitting the set of sidelink SSBs includes transmitting the set of sidelink SSBs in accordance with the alternative set of transmit beams and the alternative set of transmit beam repetition patterns.

Some examples of the method, apparatuses, and non-transitory computer-readable medium described herein may further include operations, features, means, or instructions for transmitting, to the network entity, a request for the first sidelink information, where receiving the first sidelink information may be based on transmitting the request.

In some examples of the method, apparatuses, and non-transitory computer-readable medium described herein, the first sidelink information includes location information of the second UE, mobility information of the second UE, a first channel profile of a first link between the first UE and the network entity, a second channel profile of a second link between the second UE and the network entity, a third channel profile of a third link between the second UE and a third UE and location information of the third UE, or any combination thereof.

In some examples of the method, apparatuses, and non-transitory computer-readable medium described herein, the set of transmit beams and the set of transmit beam repetition patterns may be associated with a set of sidelink SSB occasions, each sidelink SSB occasion of the set of sidelink SSB occasions includes a sub-occasion group of one or more sub-occasions, each sub-occasion of a given sub-occasion group may be associated with a same transmit beam, and different sub-occasion groups may be associated with different transmit beams.

Some examples of the method, apparatuses, and non-transitory computer-readable medium described herein may further include operations, features, means, or instructions for receiving, from the network entity, second sidelink information associated with the first UE, the second UE, or both, predicting, by the first UE based on the second sidelink information, a directional beam associated with a sidelink data message, and communicating the sidelink data message with the second UE based on the directional beam.

In some examples of the method, apparatuses, and non-transitory computer-readable medium described herein, predicting the directional beam associated with the sidelink data message may include operations, features, means, or instructions for inputting the second sidelink information into a model configured to predict one or more communication characteristics associated with the sidelink data message and obtaining, from the model, the directional beam.

Some examples of the method, apparatuses, and non-transitory computer-readable medium described herein may further include operations, features, means, or instructions for transmitting, to the network entity, an indication of the directional beam.

Some examples of the method, apparatuses, and non-transitory computer-readable medium described herein may further include operations, features, means, or instructions for receiving, from the network entity, a request for the indication of the directional beam, where communicating the indication of the directional beam may be based on receiving the request.

Some examples of the method, apparatuses, and non-transitory computer-readable medium described herein may further include operations, features, means, or instructions for transmitting, to the network entity, a request to report the indication of the directional beam, where receiving the request for the indication of the directional beam may be based on transmitting the request to report the indication of the directional beam.

Some examples of the method, apparatuses, and non-transitory computer-readable medium described herein may further include operations, features, means, or instructions for receiving, from the network entity, a confirmation of the directional beam, where communicating the sidelink data message includes transmitting or receiving the sidelink data message using the directional beam.

Some examples of the method, apparatuses, and non-transitory computer-readable medium described herein may further include operations, features, means, or instructions for receiving, from the network entity, an indication of an alternative directional beam, where communicating the sidelink data message includes transmitting or receiving the sidelink data message using the alternative directional beam.

In some examples of the method, apparatuses, and non-transitory computer-readable medium described herein, the second sidelink information includes a reference signal receive power associated with at least one of the set of sidelink SSBs, one or more receive beams and one or more receive beam repetition patterns used by the second UE, the first sidelink information, or any combination thereof.

A method for wireless communications at a first UE is described. The method may include receiving, from a network entity, an indication of first sidelink information associated with the first UE, a second UE, or both, predicting, by the first UE based on the first sidelink information, a set of receive beams and a set of receive beam repetition patterns associated with a set of sidelink SSBs, and receiving, from the second UE, the set of sidelink SSBs based on the set of receive beams and the set of receive beam repetition patterns.

An apparatus for wireless communications at a first UE is described. The apparatus may include a processor, memory coupled with the processor, and instructions stored in the memory. The instructions may be executable by the processor to cause the apparatus to receive, from a network entity, an indication of first sidelink information associated with the first UE, a second UE, or both, predict, by the first UE based on the first sidelink information, a set of receive beams and a set of receive beam repetition patterns associated with a set of sidelink SSBs, and receive, from the second UE, the set of sidelink SSBs based on the set of receive beams and the set of receive beam repetition patterns.

Another apparatus for wireless communications at a first UE is described. The apparatus may include means for receiving, from a network entity, an indication of first sidelink information associated with the first UE, a second UE, or both, means for predicting, by the first UE based on the first sidelink information, a set of receive beams and a set of receive beam repetition patterns associated with a set of sidelink SSBs, and means for receiving, from the second UE, the set of sidelink SSBs based on the set of receive beams and the set of receive beam repetition patterns.

A non-transitory computer-readable medium storing code for wireless communications at a first UE is described. The code may include instructions executable by a processor to receive, from a network entity, an indication of first sidelink information associated with the first UE, a second UE, or both, predict, by the first UE based on the first sidelink information, a set of receive beams and a set of receive beam repetition patterns associated with a set of sidelink SSBs, and receive, from the second UE, the set of sidelink SSBs based on the set of receive beams and the set of receive beam repetition patterns.

In some examples of the method, apparatuses, and non-transitory computer-readable medium described herein, the predicting may include operations, features, means, or instructions for inputting the first sidelink information into a model configured to predict one or more reception characteristics associated with the set of sidelink SSBs and obtaining, from the model, the set of receive beams and the set of receive beam repetition patterns.

Some examples of the method, apparatuses, and non-transitory computer-readable medium described herein may further include operations, features, means, or instructions for transmitting, to the network entity, an indication of the set of receive beams and the set of receive beam repetition patterns.

In some examples of the method, apparatuses, and non-transitory computer-readable medium described herein, transmitting the indication of the set of receive beams and the set of receive beam repetition patterns may include operations, features, means, or instructions for transmitting an identifier associated with the set of receive beams and the set of receive beam repetition patterns, where respective pairings of different sets of receive beams and different sets of receive beam repetition patterns may be associated with a respective identifier of a set of identifiers.

Some examples of the method, apparatuses, and non-transitory computer-readable medium described herein may further include operations, features, means, or instructions for receiving, from the network entity, a confirmation of the set of receive beams and the set of receive beam repetition patterns, where receiving the set of sidelink SSBs includes receiving the set of sidelink SSBs in accordance with the set of receive beams and the set of receive beam repetition patterns.

Some examples of the method, apparatuses, and non-transitory computer-readable medium described herein may further include operations, features, means, or instructions for receiving, from the network entity, an indication of an alternative set of receive beams and an alternative set of receive beam repetition patterns, where receiving the set of sidelink SSBs includes receiving the set of sidelink SSBs in accordance with the alternative set of receive beams and the alternative set of receive beam repetition patterns.

In some examples of the method, apparatuses, and non-transitory computer-readable medium described herein, the first sidelink information includes location information of the second UE, mobility information of the second UE, a first channel profile of a first link between the first UE and the network entity, a second channel profile of a second link between the second UE and the network entity, a third channel profile of a third link between the second UE and a third UE and location information of the third UE, or any combination thereof.

Some examples of the method, apparatuses, and non-transitory computer-readable medium described herein may further include operations, features, means, or instructions for receiving, from the network entity, second sidelink information associated with the first UE, the second UE, or both, predicting, by the first UE based on the second sidelink information, a directional beam associated with a sidelink data message, and communicating the sidelink data message with the second UE based on the directional beam.

In some examples of the method, apparatuses, and non-transitory computer-readable medium described herein, predicting the directional beam associated with the sidelink data message may include operations, features, means, or instructions for inputting the second sidelink information into a model configured to predict one or more communication characteristics associated with the sidelink data message and obtaining, from the model, the directional beam.

In some examples of the method, apparatuses, and non-transitory computer-readable medium described herein, the second sidelink information includes a reference signal receive power associated with at least one of the set of sidelink SSBs, one or more receive beams and one or more receive beam repetition patterns used by the second UE, the first sidelink information, or any combination thereof.

A method for wireless communications at a network entity is described. The method may include obtaining first sidelink information associated with a first UE, a second UE, or both, transmitting, to the first UE, the first sidelink information associated with the first UE, the second UE, or both, and receiving, from the first UE, an indication of a set of directional beams and a set of directional beam repetition patterns based on the first sidelink information, where the set of directional beams and the set of directional beam repetition patterns are predictions for a set of sidelink SSBs to be transmitted between the first UE and the second UE.

An apparatus for wireless communications at a network entity is described. The apparatus may include a processor, memory coupled with the processor, and instructions stored in the memory. The instructions may be executable by the processor to cause the apparatus to obtain first sidelink information associated with a first UE, a second UE, or both, transmit, to the first UE, the first sidelink information associated with the first UE, the second UE, or both, and receive, from the first UE, an indication of a set of directional beams and a set of directional beam repetition patterns based on the first sidelink information, where the set of directional beams and the set of directional beam repetition patterns are predictions for a set of sidelink SSBs to be transmitted between the first UE and the second UE.

Another apparatus for wireless communications at a network entity is described. The apparatus may include means for obtaining first sidelink information associated with a first UE, a second UE, or both, means for transmitting, to the first UE, the first sidelink information associated with the first UE, the second UE, or both, and means for receiving, from the first UE, an indication of a set of directional beams and a set of directional beam repetition patterns based on the first sidelink information, where the set of directional beams and the set of directional beam repetition patterns are predictions for a set of sidelink SSBs to be transmitted between the first UE and the second UE.

A non-transitory computer-readable medium storing code for wireless communications at a network entity is described. The code may include instructions executable by a processor to obtain first sidelink information associated with a first UE, a second UE, or both, transmit, to the first UE, the first sidelink information associated with the first UE, the second UE, or both, and receive, from the first UE, an indication of a set of directional beams and a set of directional beam repetition patterns based on the first sidelink information, where the set of directional beams and the set of directional beam repetition patterns are predictions for a set of sidelink SSBs to be transmitted between the first UE and the second UE.

In some examples of the method, apparatuses, and non-transitory computer-readable medium described herein, receiving the indication of the set of directional beams and the set of directional beam repetition patterns may include operations, features, means, or instructions for receiving an identifier associated with the set of directional beams and the set of directional beam repetition patterns, where respective pairings of different sets of directional beams and different sets of directional beam repetition patterns may be associated with a respective identifier of a set of identifiers.

Some examples of the method, apparatuses, and non-transitory computer-readable medium described herein may further include operations, features, means, or instructions for transmitting, to the first UE, a request for the indication of the set of directional beams and the set of directional beam repetition patterns, where receiving the indication of the set of directional beams and the set of directional beam repetition patterns may be based on transmitting the request.

Some examples of the method, apparatuses, and non-transitory computer-readable medium described herein may further include operations, features, means, or instructions for transmitting, to the first UE, a confirmation of the set of directional beams and the set of directional beam repetition patterns and transmitting, to the first UE, an indication of an alternative set of directional beams and an alternative set of directional beam repetition patterns.

In some examples of the method, apparatuses, and non-transitory computer-readable medium described herein, the first sidelink information includes location information of the second UE, mobility information of the second UE, a first channel profile of a first link between the first UE and the network entity, a second channel profile of a second link between the second UE and the network entity, a third channel profile of a third link between the second UE and a third UE and location information of the third UE, or any combination thereof.

In some examples of the method, apparatuses, and non-transitory computer-readable medium described herein, the set of directional beams and the set of directional beam repetition patterns may be associated with a set of sidelink SSB occasions, each sidelink SSB occasion of the set of sidelink SSB occasions includes a sub-occasion group of one or more sub-occasions, each sub-occasion of a given sub-occasion group may be associated with a same directional beam, and different sub-occasion groups may be associated with different directional beams.

Some examples of the method, apparatuses, and non-transitory computer-readable medium described herein may further include operations, features, means, or instructions for obtaining second sidelink information from the first UE, the second UE, or both, transmitting, to the first UE, the second sidelink information associated with the first UE, the second UE, or both, and receiving, from the first UE, an indication of a directional beam, where the directional beam may be a prediction for a sidelink data message to be transmitted between the first UE and the second UE.

In some examples of the method, apparatuses, and non-transitory computer-readable medium described herein, the second sidelink information includes a reference signal receive power associated with at least one of the set of sidelink SSBs, one or more receive beams and one or more receive beam repetition patterns used by the second UE, the first sidelink information, or any combination thereof.

Some examples of the method, apparatuses, and non-transitory computer-readable medium described herein may further include operations, features, means, or instructions for transmitting, to the second UE, an indication of the set of directional beams and the set of directional beam repetition patterns in accordance with the set of directional beams and the set of directional beam repetition patterns being the predictions for the set of sidelink SSBs to be transmitted between the first UE and the second UE.

### BRIEF DESCRIPTION OF THE DRAWINGS

FIG. 1 illustrates an example of a wireless communications system that supports machine learning based predictive initial beam pairing for sidelink in accordance with one or more aspects of the present disclosure.

FIG. 2 illustrates an example of a signaling diagram that supports machine learning based predictive initial beam pairing for sidelink in accordance with one or more aspects of the present disclosure.

FIG. 3 illustrates an example of a learning model that supports machine learning based predictive initial beam pairing for sidelink in accordance with one or more aspects of the present disclosure.

FIG. 4 illustrates an example of a communication timeline that supports machine learning based predictive initial beam pairing for sidelink in accordance with one or more aspects of the present disclosure.

FIGS. 5 and 6 illustrate examples of process flows that support machine learning based predictive initial beam pairing for sidelink in accordance with one or more aspects of the present disclosure.

FIGS. 7 and 8 show block diagrams of devices that support machine learning based predictive initial beam pairing for sidelink in accordance with one or more aspects of the present disclosure.

FIG. 9 shows a block diagram of a communications manager that supports machine learning based predictive initial beam pairing for sidelink in accordance with one or more aspects of the present disclosure.

FIG. 10 shows a diagram of a system including a device that supports machine learning based predictive initial beam pairing for sidelink in accordance with one or more aspects of the present disclosure.

FIGS. 11 and 12 show block diagrams of devices that support machine learning based predictive initial beam pairing for sidelink in accordance with one or more aspects of the present disclosure.

FIG. 13 shows a block diagram of a communications manager that supports machine learning based predictive initial beam pairing for sidelink in accordance with one or more aspects of the present disclosure.

FIG. 14 shows a diagram of a system including a device that supports machine learning based predictive initial beam pairing for sidelink in accordance with one or more aspects of the present disclosure.

FIGS. 15 through 17 show flowcharts illustrating methods that support machine learning based predictive initial beam pairing for sidelink in accordance with one or more aspects of the present disclosure.

### DETAILED DESCRIPTION

In some wireless communications systems, a user equipment (UE) may communicate directionally (e.g., using beamforming) with another UE. In such systems, the two UEs may establish a transmit and receive beam pair that provides a sufficient link quality between the two UEs, which may involve one or more beam sweeping procedures at one or both of the UEs. In some systems, such beam sweeping procedures may be associated with a relatively high latency. To reduce the latency associated with beam sweeping procedures at one or both UEs, a network entity may, in some cases, control a beam repetition pattern of one UE and indicate the pattern to the other UE. In such cases, however, which metrics the network entity may use to select such a pattern lack definition and may vary across different deployment scenarios. Further, in some other cases, one UE may use sidelink information (e.g., location information, mobility information, channel information, or beam information) of one or both of the two UEs to help select which beams to use for its beam sweeping procedure, but such information may be highly non-linear and may not be compatible with some statistical signal processing schemes (such as some ways of selecting or estimating which beam or beams might provide a suitable link based on statistics).

In some implementations of the present disclosure, a network entity and at least a first UE may support a signaling mechanism that enables the first UE to predict one or more directional beams for sidelink communication between the first UE and a second UE in accordance with sidelink information associated with one or both of the first UE and the second UE. For example, the network entity may transmit, to the first UE, sidelink information (which may include location information, mobility information, channel profile information, or any combination thereof) associated with one or both of the first UE and the second UE and the first UE may use the sidelink information to predict one or more directional beams. In some implementations, the first UE may use the one or more directional beams to transmit or receive one or more sidelink synchronization signal blocks (SSBs) to or from the second UE. Additionally, or alternatively the first UE may use the one or more directional beams to communicate a sidelink data message with the second UE (e.g., to transmit or receive the sidelink data message to or from the second UE). In some implementations, the first UE may use a model, such as a machine learning or an artificial intelligence model, to predict the one or more directional beams. Further, in some implementations, the signaling mechanism may include beam reporting to the network entity from the first UE and beam confirmation or reversion messaging from the network entity to the first UE.

Particular implementations of the subject matter described herein may be implemented to realize one or more advantages. For example, as a result of supporting a signaling mechanism that facilitates machine learning based predictive beam pairing for sidelink, two UEs may establish an initial beam pair link with lower latency and with potentially fewer sweeps of fewer candidate beams. As such, the two UEs may consume fewer communication resources (e.g., fewer time and frequency resources) and less battery power, which may support greater spectral efficiency along with longer battery life for at least one of the two UEs. Further, and in accordance with supporting greater spectral efficiency, the network entity and the two UEs may experience higher data rates and may support greater system capacity, among other benefits.

Aspects of the disclosure are initially described in the context of wireless communications systems. Aspects of the disclosure are additionally illustrated by and described herein with reference to a signaling diagram, a learning model, a communication timeline, and process flows. Aspects of the disclosure are further illustrated by and described herein with reference to apparatus diagrams, system diagrams, and flowcharts that relate to machine learning based predictive initial beam pairing for sidelink.

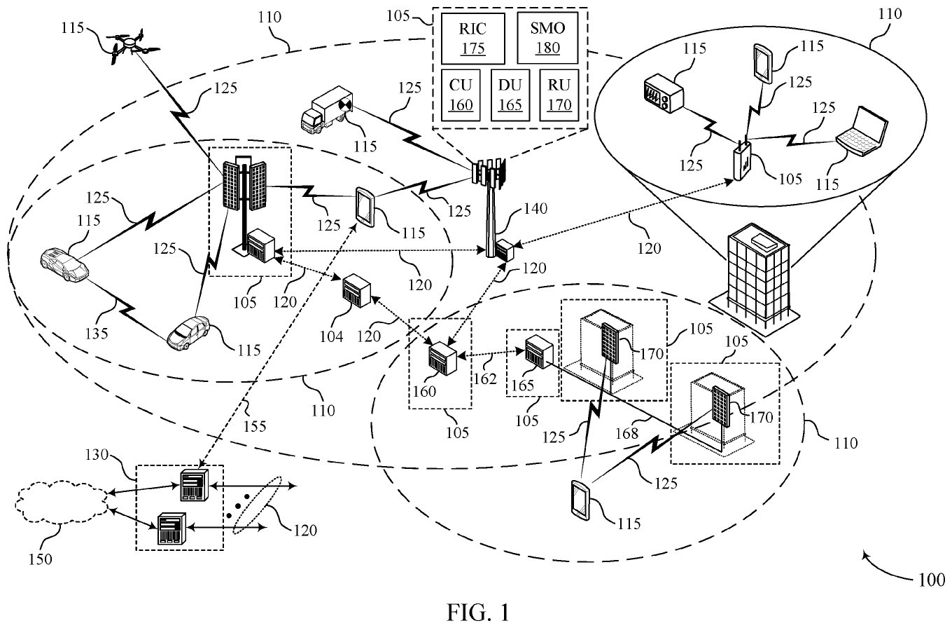

FIG. 1 illustrates an example of a wireless communications system 100 that supports machine learning based predictive initial beam pairing for sidelink in accordance with one or more aspects of the present disclosure. The wireless communications system 100 may include one or more network entities 105, one or more UEs 115, and a core network 130. In some examples, the wireless communications system 100 may be a Long Term Evolution (LTE) network, an LTE-Advanced (LTE-A) network, an LTE-A Pro network, a New Radio (NR) network, or a network operating in accordance with other systems and radio technologies, including future systems and radio technologies not explicitly mentioned herein.

The network entities 105 may be dispersed throughout a geographic area to form the wireless communications system 100 and may include devices in different forms or having different capabilities. In various examples, a network entity 105 may be referred to as a network element, a mobility element, a radio access network (RAN) node, or network equipment, among other nomenclature. In some examples, network entities 105 and UEs 115 may wirelessly communicate via one or more communication links 125 (e.g., a radio frequency (RF) access link). For example, a network entity 105 may support a coverage area 110 (e.g., a geographic coverage area) over which the UEs 115 and the network entity 105 may establish one or more communication links 125. The coverage area 110 may be an example of a geographic area over which a network entity 105 and a UE 115 may support the communication of signals according to one or more radio access technologies (RATs).

The UEs 115 may be dispersed throughout a coverage area 110 of the wireless communications system 100, and each UE 115 may be stationary, or mobile, or both at different times. The UEs 115 may be devices in different forms or having different capabilities. Some example UEs 115 are illustrated in FIG. 1. The UEs 115 described herein may be capable of supporting communications with various types of devices, such as other UEs 115 or network entities 105, as shown in FIG. 1.

As described herein, a node of the wireless communications system 100, which may be referred to as a network node, or a wireless node, may be a network entity 105 (e.g., any network entity described herein), a UE 115 (e.g., any UE described herein), a network controller, an apparatus, a device, a computing system, one or more components, or another suitable processing entity configured to perform any of the techniques described herein. For example, a node may be a UE 115. As another example, a node may be a network entity 105. As another example, a first node may be configured to communicate with a second node or a third node. In one aspect of this example, the first node may be a UE 115, the second node may be a network entity 105, and the third node may be a UE 115. In another aspect of this example, the first node may be a UE 115, the second node may be a network entity 105, and the third node may be a network entity 105. In yet other aspects of this example, the first, second, and third nodes may be different relative to these examples. Similarly, reference to a UE 115, network entity 105, apparatus, device, computing system, or the like may include disclosure of the UE 115, network entity 105, apparatus, device, computing system, or the like being a node. For example, disclosure that a UE 115 is configured to receive information from a network entity 105 also discloses that a first node is configured to receive information from a second node.

In some examples, network entities 105 may communicate with the core network 130, or with one another, or both. For example, network entities 105 may communicate with the core network 130 via one or more backhaul communication links 120 (e.g., in accordance with an S1, N2, N3, or other interface protocol). In some examples, network entities 105 may communicate with one another via a backhaul communication link 120 (e.g., in accordance with an X2, Xn, or other interface protocol) either directly (e.g., directly between network entities 105) or indirectly (e.g., via a core network 130). In some examples, network entities 105 may communicate with one another via a midhaul communication link 162 (e.g., in accordance with a midhaul interface protocol) or a fronthaul communication link 168 (e.g., in accordance with a fronthaul interface protocol), or any combination thereof. The backhaul communication links 120, midhaul communication links 162, or fronthaul communication links 168 may be or include one or more wired links (e.g., an electrical link, an optical fiber link), one or more wireless links (e.g., a radio link, a wireless optical link), among other examples or various combinations thereof. A UE 115 may communicate with the core network 130 via a communication link 155.

One or more of the network entities 105 described herein may include or may be referred to as a base station 140 (e.g., a base transceiver station, a radio base station, an NR base station, an access point, a radio transceiver, a NodeB, an eNodeB (eNB), a next-generation NodeB or a giga-NodeB (either of which may be referred to as a gNB), a 5G NB, a next-generation eNB (ng-eNB), a Home NodeB, a Home eNodeB, or other suitable terminology). In some examples, a network entity 105 (e.g., a base station 140) may be implemented in an aggregated (e.g., monolithic, standalone) base station architecture, which may be configured to utilize a protocol stack that is physically or logically integrated within a single network entity 105 (e.g., a single RAN node, such as a base station 140).

In some examples, a network entity 105 may be implemented in a disaggregated architecture (e.g., a disaggregated base station architecture, a disaggregated RAN architecture), which may be configured to utilize a protocol stack that is physically or logically distributed among two or more network entities 105, such as an integrated access backhaul (IAB) network, an open RAN (O-RAN) (e.g., a network configuration sponsored by the O-RAN Alliance), or a virtualized RAN (vRAN) (e.g., a cloud RAN (C-RAN)). For example, a network entity 105 may include one or more of a central unit (CU) 160, a distributed unit (DU) 165, a radio unit (RU) 170, a RAN Intelligent Controller (RIC) 175 (e.g., a Near-Real Time RIC (Near-RT RIC), a Non-Real Time RIC (Non-RT RIC)), a Service Management and Orchestration (SMO) 180 system, or any combination thereof. An RU 170 may also be referred to as a radio head, a smart radio head, a remote radio head (RRH), a remote radio unit (RRU), or a transmission reception point (TRP). One or more components of the network entities 105 in a disaggregated RAN architecture may be co-located, or one or more components of the network entities 105 may be located in distributed locations (e.g., separate physical locations). In some examples, one or more network entities 105 of a disaggregated RAN architecture may be implemented as virtual units (e.g., a virtual CU (VCU), a virtual DU (VDU), a virtual RU (VRU)).

The split of functionality between a CU 160, a DU 165, and an RU 170 is flexible and may support different functionalities depending upon which functions (e.g., network layer functions, protocol layer functions, baseband functions, RF functions, and any combinations thereof) are performed at a CU 160, a DU 165, or an RU 170. For example, a functional split of a protocol stack may be employed between a CU 160 and a DU 165 such that the CU 160 may support one or more layers of the protocol stack and the DU 165 may support one or more different layers of the protocol stack. In some examples, the CU 160 may host upper protocol layer (e.g., layer 3 (L3), layer 2 (L2)) functionality and signaling (e.g., Radio Resource Control (RRC), service data adaption protocol (SDAP), Packet Data Convergence Protocol (PDCP)). The CU 160 may be connected to one or more DUs 165 or RUs 170, and the one or more DUs 165 or RUs 170 may host lower protocol layers, such as layer 1 (L1) (e.g., physical (PHY) layer) or L2 (e.g., radio link control (RLC) layer, medium access control (MAC) layer) functionality and signaling, and may each be at least partially controlled by the CU 160. Additionally, or alternatively, a functional split of the protocol stack may be employed between a DU 165 and an RU 170 such that the DU 165 may support one or more layers of the protocol stack and the RU 170 may support one or more different layers of the protocol stack. The DU 165 may support one or multiple different cells (e.g., via one or more RUs 170). In some cases, a functional split between a CU 160 and a DU 165, or between a DU 165 and an RU 170 may be within a protocol layer (e.g., some functions for a protocol layer may be performed by one of a CU 160, a DU 165, or an RU 170, while other functions of the protocol layer are performed by a different one of the CU 160, the DU 165, or the RU 170). A CU 160 may be functionally split further into CU control plane (CU-CP) and CU user plane (CU-UP) functions. A CU 160 may be connected to one or more DUs 165 via a midhaul communication link 162 (e.g., F1, F1-c, F1-u), and a DU 165 may be connected to one or more RUs 170 via a fronthaul communication link 168 (e.g., open fronthaul (FH) interface). In some examples, a midhaul communication link 162 or a fronthaul communication link 168 may be implemented in accordance with an interface (e.g., a channel) between layers of a protocol stack supported by respective network entities 105 that are in communication via such communication links.

In wireless communications systems (e.g., wireless communications system 100), infrastructure and spectral resources for radio access may support wireless backhaul link capabilities to supplement wired backhaul connections, providing an IAB network architecture (e.g., to a core network 130). In some cases, in an IAB network, one or more network entities 105 (e.g., IAB nodes 104) may be partially controlled by each other. One or more IAB nodes 104 may be referred to as a donor entity or an IAB donor. One or more DUs 165 or one or more RUs 170 may be partially controlled by one or more CUs 160 associated with a donor network entity 105 (e.g., a donor base station 140). The one or more donor network entities 105 (e.g., IAB donors) may be in communication with one or more additional network entities 105 (e.g., IAB nodes 104) via supported access and backhaul links (e.g., backhaul communication links 120). IAB nodes 104 may include an IAB mobile termination (IAB-MT) controlled (e.g., scheduled) by DUs 165 of a coupled IAB donor. An IAB-MT may include an independent set of antennas for relay of communications with UEs 115, or may share the same antennas (e.g., of an RU 170) of an IAB node 104 used for access via the DU 165 of the IAB node 104 (e.g., referred to as virtual IAB-MT (vIAB-MT)). In some examples, the IAB nodes 104 may include DUs 165 that support communication links with additional entities (e.g., IAB nodes 104, UEs 115) within the relay chain or configuration of the access network (e.g., downstream). In such cases, one or more components of the disaggregated RAN architecture (e.g., one or more IAB nodes 104 or components of IAB nodes 104) may be configured to operate according to the techniques described herein.

In the case of the techniques described herein applied in the context of a disaggregated RAN architecture, one or more components of the disaggregated RAN architecture may be configured to support machine learning based predictive initial beam pairing for sidelink as described herein. For example, some operations described as being performed by a UE 115 or a network entity 105 (e.g., a base station 140) may additionally, or alternatively, be performed by one or more components of the disaggregated RAN architecture (e.g., IAB nodes 104, DUs 165, CUs 160, RUs 170, RIC 175, SMO 180).

A UE 115 may include or may be referred to as a mobile device, a wireless device, a remote device, a handheld device, or a subscriber device, or some other suitable terminology, where the “device” may also be referred to as a unit, a station, a terminal, or a client, among other examples. A UE 115 may also include or may be referred to as a personal electronic device such as a cellular phone, a personal digital assistant (PDA), a tablet computer, a laptop computer, or a personal computer. In some examples, a UE 115 may include or be referred to as a wireless local loop (WLL) station, an Internet of Things (IoT) device, an Internet of Everything (IoE) device, or a machine type communications (MTC) device, among other examples, which may be implemented in various objects such as appliances, or vehicles, meters, among other examples.

The UEs 115 described herein may be able to communicate with various types of devices, such as other UEs 115 that may sometimes act as relays as well as the network entities 105 and the network equipment including macro eNBs or gNBs, small cell eNBs or gNBs, or relay base stations, among other examples, as shown in FIG. 1.

The UEs 115 and the network entities 105 may wirelessly communicate with one another via one or more communication links 125 (e.g., an access link) using resources associated with one or more carriers. The term “carrier” may refer to a set of RF spectrum resources having a defined physical layer structure for supporting the communication links 125. For example, a carrier used for a communication link 125 may include a portion of a RF spectrum band (e.g., a bandwidth part (BWP)) that is operated according to one or more physical layer channels for a given radio access technology (e.g., LTE, LTE-A, LTE-A Pro, NR). Each physical layer channel may carry acquisition signaling (e.g., synchronization signals, system information), control signaling that coordinates operation for the carrier, user data, or other signaling. The wireless communications system 100 may support communication with a UE 115 using carrier aggregation or multi-carrier operation. A UE 115 may be configured with multiple downlink component carriers and one or more uplink component carriers according to a carrier aggregation configuration. Carrier aggregation may be used with both frequency division duplexing (FDD) and time division duplexing (TDD) component carriers. Communication between a network entity 105 and other devices may refer to communication between the devices and any portion (e.g., entity, sub-entity) of a network entity 105. For example, the terms “transmitting,” “receiving,” or “communicating,” when referring to a network entity 105, may refer to any portion of a network entity 105 (e.g., a base station 140, a CU 160, a DU 165, a RU 170) of a RAN communicating with another device (e.g., directly or via one or more other network entities 105).

Signal waveforms transmitted via a carrier may be made up of multiple subcarriers (e.g., using multi-carrier modulation (MCM) techniques such as orthogonal frequency division multiplexing (OFDM) or discrete Fourier transform spread OFDM

(DFT-S-OFDM)). In a system employing MCM techniques, a resource element may refer to resources of one symbol period (e.g., a duration of one modulation symbol) and one subcarrier, in which case the symbol period and subcarrier spacing may be inversely related. The quantity of bits carried by each resource element may depend on the modulation scheme (e.g., the order of the modulation scheme, the coding rate of the modulation scheme, or both), such that a relatively higher quantity of resource elements (e.g., in a transmission duration) and a relatively higher order of a modulation scheme may correspond to a relatively higher rate of communication. A wireless communications resource may refer to any combination of an RF spectrum resource, a time resource, and a spatial resource (e.g., a spatial layer, a beam), and the use of multiple spatial resources may increase the data rate or data integrity for communications with a UE 115.

The time intervals for the network entities 105 or the UEs 115 may be expressed in multiples of a basic time unit which may, for example, refer to a sampling period of Ts=1/(Δfₘₐₓ·N_{f}) seconds, for which Δfₘₐₓ may represent a supported subcarrier spacing, and Ne may represent a supported discrete Fourier transform (DFT) size. Time intervals of a communications resource may be organized according to radio frames each having a specified duration (e.g., 10 milliseconds (ms)). Each radio frame may be identified by a system frame number (SFN) (e.g., ranging from 0 to 1023).

Each frame may include multiple consecutively-numbered subframes or slots, and each subframe or slot may have the same duration. In some examples, a frame may be divided (e.g., in the time domain) into subframes, and each subframe may be further divided into a quantity of slots. Alternatively, each frame may include a variable quantity of slots, and the quantity of slots may depend on subcarrier spacing. Each slot may include a quantity of symbol periods (e.g., depending on the length of the cyclic prefix prepended to each symbol period). In some wireless communications systems 100, a slot may further be divided into multiple mini-slots associated with one or more symbols. Excluding the cyclic prefix, each symbol period may be associated with one or more (e.g., N_{f}) sampling periods. The duration of a symbol period may depend on the subcarrier spacing or frequency band of operation.

A subframe, a slot, a mini-slot, or a symbol may be the smallest scheduling unit (e.g., in the time domain) of the wireless communications system 100 and may be referred to as a transmission time interval (TTI). In some examples, the TTI duration (e.g., a quantity of symbol periods in a TTI) may be variable. Additionally, or alternatively, the smallest scheduling unit of the wireless communications system 100 may be dynamically selected (e.g., in bursts of shortened TTIs (STTIs)).

Physical channels may be multiplexed for communication using a carrier according to various techniques. A physical control channel and a physical data channel may be multiplexed for signaling via a downlink carrier, for example, using one or more of time division multiplexing (TDM) techniques, frequency division multiplexing (FDM) techniques, or hybrid TDM-FDM techniques. A control region (e.g., a control resource set (CORESET)) for a physical control channel may be defined by a set of symbol periods and may extend across the system bandwidth or a subset of the system bandwidth of the carrier. One or more control regions (e.g., CORESETs) may be configured for a set of the UEs 115. For example, one or more of the UEs 115 may monitor or search control regions for control information according to one or more search space sets, and each search space set may include one or multiple control channel candidates in one or more aggregation levels arranged in a cascaded manner. An aggregation level for a control channel candidate may refer to an amount of control channel resources (e.g., control channel elements (CCEs)) associated with encoded information for a control information format having a given payload size. Search space sets may include common search space sets configured for sending control information to multiple UEs 115 and UE-specific search space sets for sending control information to a specific UE 115.

In some examples, a network entity 105 (e.g., a base station 140, an RU 170) may be movable and therefore provide communication coverage for a moving coverage area 110. In some examples, different coverage areas 110 associated with different technologies may overlap, but the different coverage areas 110 may be supported by the same network entity 105. In some other examples, the overlapping coverage areas 110 associated with different technologies may be supported by different network entities 105. The wireless communications system 100 may include, for example, a heterogeneous network in which different types of the network entities 105 provide coverage for various coverage areas 110 using the same or different radio access technologies.

The wireless communications system 100 may be configured to support ultra-reliable communications or low-latency communications, or various combinations thereof. For example, the wireless communications system 100 may be configured to support ultra-reliable low-latency communications (URLLC). The UEs 115 may be designed to support ultra-reliable, low-latency, or critical functions. Ultra-reliable communications may include private communication or group communication and may be supported by one or more services such as push-to-talk, video, or data. Support for ultra-reliable, low-latency functions may include prioritization of services, and such services may be used for public safety or general commercial applications. The terms ultra-reliable, low-latency, and ultra-reliable low-latency may be used interchangeably herein.

In some examples, a UE 115 may be configured to support communicating directly with other UEs 115 via a device-to-device (D2D) communication link 135 (e.g., in accordance with a peer-to-peer (P2P), D2D, or sidelink protocol). In some examples, one or more UEs 115 of a group that are performing D2D communications may be within the coverage area 110 of a network entity 105 (e.g., a base station 140, an RU 170), which may support aspects of such D2D communications being configured by (e.g., scheduled by) the network entity 105. In some examples, one or more UEs 115 of such a group may be outside the coverage area 110 of a network entity 105 or may be otherwise unable to or not configured to receive transmissions from a network entity 105. In some examples, groups of the UEs 115 communicating via D2D communications may support a one-to-many (1:M) system in which each UE 115 transmits to each of the other UEs 115 in the group. In some examples, a network entity 105 may facilitate the scheduling of resources for D2D communications. In some other examples, D2D communications may be carried out between the UEs 115 without an involvement of a network entity 105.

In some systems, a D2D communication link 135 may be an example of a communication channel, such as a sidelink communication channel, between vehicles (e.g., UEs 115). In some examples, vehicles may communicate using vehicle-to-everything (V2X) communications, vehicle-to-vehicle (V2V) communications, or some combination of these. A vehicle may signal information related to traffic conditions, signal scheduling, weather, safety, emergencies, or any other information relevant to a V2X system. In some examples, vehicles in a V2X system may communicate with roadside infrastructure, such as roadside units, or with the network via one or more network nodes (e.g., network entities 105, base stations 140, RUs 170) using vehicle-to-network (V2N) communications, or with both.

The core network 130 may provide user authentication, access authorization, tracking, Internet Protocol (IP) connectivity, and other access, routing, or mobility functions. The core network 130 may be an evolved packet core (EPC) or 5G core (5GC), which may include at least one control plane entity that manages access and mobility (e.g., a mobility management entity (MME), an access and mobility management function (AMF)) and at least one user plane entity that routes packets or interconnects to external networks (e.g., a serving gateway (S-GW), a Packet Data Network (PDN) gateway (P-GW), or a user plane function (UPF)). The control plane entity may manage non-access stratum (NAS) functions such as mobility, authentication, and bearer management for the UEs 115 served by the network entities 105 (e.g., base stations 140) associated with the core network 130. User IP packets may be transferred through the user plane entity, which may provide IP address allocation as well as other functions. The user plane entity may be connected to IP services 150 for one or more network operators. The IP services 150 may include access to the Internet, Intranet(s), an IP Multimedia Subsystem (IMS), or a Packet-Switched Streaming Service.

The wireless communications system 100 may operate using one or more frequency bands, which may be in the range of 300 megahertz (MHz) to 300 gigahertz (GHz). Generally, the region from 300 MHz to 3 GHz is known as the ultra-high frequency (UHF) region or decimeter band because the wavelengths range from approximately one decimeter to one meter in length. UHF waves may be blocked or redirected by buildings and environmental features, which may be referred to as clusters, but the waves may penetrate structures sufficiently for a macro cell to provide service to the UEs 115 located indoors. Communications using UHF waves may be associated with smaller antennas and shorter ranges (e.g., less than 100 kilometers) compared to communications using the smaller frequencies and longer waves of the high frequency (HF) or very high frequency (VHF) portion of the spectrum below 300 MHz.

The wireless communications system 100 may also operate using a super high frequency (SHF) region, which may be in the range of 3 GHz to 30 GHz, also known as the centimeter band, or using an extremely high frequency (EHF) region of the spectrum (e.g., from 30 GHz to 300 GHz), also known as the millimeter band. In some examples, the wireless communications system 100 may support millimeter wave (mmW) communications between the UEs 115 and the network entities 105 (e.g., base stations 140, RUs 170), and EHF antennas of the respective devices may be smaller and more closely spaced than UHF antennas. In some examples, such techniques may facilitate using antenna arrays within a device. The propagation of EHF transmissions, however, may be subject to even greater attenuation and shorter range than SHF or UHF transmissions. The techniques disclosed herein may be employed across transmissions that use one or more different frequency regions, and designated use of bands across these frequency regions may differ by country or regulating body.

The wireless communications system 100 may utilize both licensed and unlicensed RF spectrum bands. For example, the wireless communications system 100 may employ License Assisted Access (LAA), LTE-Unlicensed (LTE-U) radio access technology, or NR technology using an unlicensed band such as the 5 GHz industrial, scientific, and medical (ISM) band. While operating using unlicensed RF spectrum bands, devices such as the network entities 105 and the UEs 115 may employ carrier sensing for collision detection and avoidance. In some examples, operations using unlicensed bands may be based on a carrier aggregation configuration in conjunction with component carriers operating using a licensed band (e.g., LAA). Operations using unlicensed spectrum may include downlink transmissions, uplink transmissions, P2P transmissions, or D2D transmissions, among other examples.

A network entity 105 (e.g., a base station 140, an RU 170) or a UE 115 may be equipped with multiple antennas, which may be used to employ techniques such as transmit diversity, receive diversity, multiple-input multiple-output (MIMO) communications, or beamforming. The antennas of a network entity 105 or a UE 115 may be located within one or more antenna arrays or antenna panels, which may support MIMO operations or transmit or receive beamforming. For example, one or more base station antennas or antenna arrays may be co-located at an antenna assembly, such as an antenna tower. In some examples, antennas or antenna arrays associated with a network entity 105 may be located at diverse geographic locations. A network entity 105 may include an antenna array with a set of rows and columns of antenna ports that the network entity 105 may use to support beamforming of communications with a UE 115. Likewise, a UE 115 may include one or more antenna arrays that may support various MIMO or beamforming operations. Additionally, or alternatively, an antenna panel may support RF beamforming for a signal transmitted via an antenna port.

Beamforming, which may also be referred to as spatial filtering, directional transmission, or directional reception, is a signal processing technique that may be used at a transmitting device or a receiving device (e.g., a network entity 105, a UE 115) to shape or steer an antenna beam (e.g., a transmit beam, a receive beam) along a spatial path between the transmitting device and the receiving device. Beamforming may be achieved by combining the signals communicated via antenna elements of an antenna array such that some signals propagating along particular orientations with respect to an antenna array experience constructive interference while others experience destructive interference. The adjustment of signals communicated via the antenna elements may include a transmitting device or a receiving device applying amplitude offsets, phase offsets, or both to signals carried via the antenna elements associated with the device. The adjustments associated with each of the antenna elements may be defined by a beamforming weight set associated with a particular orientation (e.g., with respect to the antenna array of the transmitting device or receiving device, or with respect to some other orientation).

A network entity 105 or a UE 115 may use beam sweeping techniques as part of beamforming operations. For example, a network entity 105 (e.g., a base station 140, an RU 170) may use multiple antennas or antenna arrays (e.g., antenna panels) to conduct beamforming operations for directional communications with a UE 115. Some signals (e.g., synchronization signals, reference signals, beam selection signals, or other control signals) may be transmitted by a network entity 105 multiple times along different directions. For example, the network entity 105 may transmit a signal according to different beamforming weight sets associated with different directions of transmission. Transmissions along different beam directions may be used to identify (e.g., by a transmitting device, such as a network entity 105, or by a receiving device, such as a UE 115) a beam direction for later transmission or reception by the network entity 105.

Some signals, such as data signals associated with a particular receiving device, may be transmitted by transmitting device (e.g., a transmitting network entity 105, a transmitting UE 115) along a single beam direction (e.g., a direction associated with the receiving device, such as a receiving network entity 105 or a receiving UE 115). In some examples, the beam direction associated with transmissions along a single beam direction may be determined based on a signal that was transmitted along one or more beam directions. For example, a UE 115 may receive one or more of the signals transmitted by the network entity 105 along different directions and may report to the network entity 105 an indication of the signal that the UE 115 received with a highest signal quality or an otherwise acceptable signal quality.

In some examples, transmissions by a device (e.g., by a network entity 105 or a UE 115) may be performed using multiple beam directions, and the device may use any combination of digital precoding or beamforming to generate a combined beam for transmission (e.g., from a network entity 105 to a UE 115). The UE 115 may report feedback that indicates precoding weights for one or more beam directions, and the feedback may correspond to a configured set of beams across a system bandwidth or one or more sub-bands. The network entity 105 may transmit a reference signal (e.g., a cell-specific reference signal (CRS), a channel state information reference signal (CSI-RS)), which may be precoded or unprecoded. The UE 115 may provide feedback for beam selection, which may be a precoding matrix indicator (PMI) or codebook-based feedback (e.g., a multi-panel type codebook, a linear combination type codebook, a port selection type codebook). Although these techniques are described herein with reference to signals transmitted along one or more directions by a network entity 105 (e.g., a base station 140, an RU 170), a UE 115 may employ similar techniques for transmitting signals multiple times along different directions (e.g., for identifying a beam direction for subsequent transmission or reception by the UE 115) or for transmitting a signal along a single direction (e.g., for transmitting data to a receiving device).

A receiving device (e.g., a UE 115) may perform reception operations in accordance with multiple receive configurations (e.g., directional listening) when receiving various signals from a receiving device (e.g., a network entity 105), such as synchronization signals, reference signals, beam selection signals, or other control signals. For example, a receiving device may perform reception in accordance with multiple receive directions by receiving via different antenna subarrays, by processing received signals according to different antenna subarrays, by receiving according to different receive beamforming weight sets (e.g., different directional listening weight sets) applied to signals received at multiple antenna elements of an antenna array, or by processing received signals according to different receive beamforming weight sets applied to signals received at multiple antenna elements of an antenna array, any of which may be referred to as “listening” according to different receive configurations or receive directions. In some examples, a receiving device may use a single receive configuration to receive along a single beam direction (e.g., when receiving a data signal). The single receive configuration may be aligned along a beam direction determined based on listening according to different receive configuration directions (e.g., a beam direction determined to have a highest signal strength, highest signal-to-noise ratio (SNR), or otherwise acceptable signal quality based on listening according to multiple beam directions).

In some aspects, the wireless communications system 100 may support one or more beam management techniques. For example, a UE 115 may be in an RRC idle state (e.g., RRC_IDLE) or an RRC inactive state (e.g., RRC_INACTIVE) and may transmit or receive one or more tracking reference signals (TRSs) prior to initial access. As part of initial access, one or more devices (e.g., one or both of a UE 115 and a network entity 105) may perform SSB (wide) beam sweeping. In some aspects, initial access may involve a contention based random access (CBRA) procedure associated with transmission or reception of random access channel (RACH) occasions (ROs) or preambles or transmission or reception of SSBs.

Upon establishment of a beam pair between two devices (e.g., between a UE 115 and a network entity 105), each device may perform beam management in an RRC connected state (e.g., RRC_CONNECTED). In some aspects, such beam management may include transmission or reception of one or more SSBs, one or more CSI reference signals (CSI-RSs), or one or more sounding reference signals (SRSs), Layer 1 (L1) reference signal receive power (RSRP) reporting, and transmission configuration indicator (TCI) state configuration or indication. In some aspects, beam management (e.g., SSB or CSI-RS associated beam management) may be associated with a set of processes P1, P2, and P3 that are designed for beam management while a device is in a connected state. P1 may be associated with beam selection (e.g., a network entity 105 may sweep a beam and a UE 115 may select one of the beams and report the selected beam to the network entity 105), P2 may be associated with beam refinement for the transmitter (e.g., a network entity 105 may refine a beam via sweeping a narrower beam across a narrower range and a UE 115 may select one of the narrower beams and report the selected narrower beam to the network entity 105), and P3 may be associated with beam refinement for the receiver (e.g., a network entity 105 may fix a beam and a UE 115 may refine its receive beam). In some aspects, beam management (e.g., SRS associated beam management) may be associated with a set of different uplink beam management procedures U1, U2, and U3, where each beam management procedure may be associated with a beam sweep.

Additionally, or alternatively, beam management may include L1 signal-to-interference-plus-noise ratio (SINR) reporting and overhead and latency reduction. In some aspects, overhead and latency reduction may be associated with or otherwise involve one or more component carrier (CC) group beam updates and lower latency uplink beam updates. Further, in some aspects, beam management may involve beam measurement or reporting, or both with association to unified TCI states and L1 or Layer 2 (L2) centric mobility. For example, beam management procedures may include dynamic TCI state updates, uplink multi-panel selection, maximum permissible exposure (MPE) mitigation, or other techniques that facilitate further beam management latency reduction. Further, some beam management procedures may include procedures associated high speed train (HST) deployments, single frequency network (SFN) deployments, or multi-TRP deployments, or any combination thereof.

In some aspects, a device may measure, identify, or otherwise experience a beam failure detection (BFD) based on measurements associated with beam management and may perform one or more beam failure recovery procedures. BFD and a beam failure recovery (BFR) may be performed for a primary cell (PCell), a primary secondary cell (PSCell), or a secondary cell (SCell). Further, BFD and BFR may involve transmission or reception of one or more BFD reference signals (BFD-RSs), a physical downlink control channel (PDCCH) block error rate (BLER) measurement, a link recovery request via a scheduling request (SR), or a MAC control element (MAC-CE) based BFR for SCell, or any combination thereof. In some cases, such as in cases in which a device is unable to recover a failed beam pair link, the device may declare a radio link failure (RLF) and attempt to re-establish a connection via one or more initial establishment procedures.

Various devices of the wireless communications system 100 may support one or more artificial intelligence or machine learning models associated with air-interface predictions (e.g., predictions associated with wireless communication). In some deployments, for example, a device may leverage or use an artificial intelligence or machine learning model for CSI feedback enhancement (e.g., for overhead reduction, greater accuracy, and more accurate prediction), beam management (e.g., beam prediction in time or spatial domain for overhead and latency reduction as well as for greater beam selection accuracy), or positioning accuracy enhancements for different scenarios (e.g., scenarios associated with heavy non-line-of-sight (NLOS) conditions). In some cases, the device may leverage or use an artificial intelligence or machine learning model for a specific use case such that the artificial intelligence or machine learning model approach is diverse enough to support various constraints on collaboration levels between a UE 115 and a network entity 105.

In some deployments, a UE 115 or a network entity 105 may use artificial intelligence or machine learning based predictive beam management (e.g., for Uu beam management). For example, other beam management techniques may involve an identification of beam qualities or failures via measurements, which may be associated with greater power or overhead to achieve suitable performance. Further, measurement-based beam management may be associated with a limited accuracy due to constraints on power or overhead and latency and throughput may be adversely impacted by beam resumption efforts. Predictive beam management, on the other hand, may be associated with power or overhead reduction, greater accuracy, lower latency, or higher throughput. For example, a predictive beam management procedure may enable a device to predict non-measured beam qualities (which may be associated with lower power consumption, lower overhead, or greater beam selection accuracy) and to predict future beam blockages or failures (which may be associated with lower latency and greater throughput). Such predictive beam management may involve predictions in a spatial domain, a time domain, a frequency domain, or any combination thereof.

Some devices may specifically employ artificial intelligence or machine learning to compensate or address that beam prediction may be a highly non-linear problem in some deployments. For example, predicting a future transmit beam quality may depend on a speed or trajectory of a UE 115, one or more receive beams that are to be used, or interference, among other examples, which may be difficult to model via some statistical signaling processing methods (e.g., non-artificial intelligence or machine learning based statistical processing methods). In some deployments, there may be a tradeoff between performance and UE power consumption based on whether beam prediction is performed at a UE 115 or a network entity 105. For example, to predict future downlink transmit beam qualities, a UE 115 may have more observations (e.g., via measurements) than a network entity 105 (e.g., via UE feedback messages), thus beam prediction at a UE 115 may outperform beam prediction at a network entity 105 (at the cost of consuming more UE power for the prediction or inference processing tasks). Further, model training may be performed at either a UE 115 or a network entity 105 and a decision between training location may be associated with efforts on data collection as compared to efforts on UE computation. For example, if training is performed by a network entity 105, data may be collected via an air interface or via application layer approaches. If training is performed by a UE 115, the UE 115 may perform additional UE computation or buffering tasks for the model training and associated data storage.

In an example of time domain beam prediction, a network entity 105 may sweep transmissions across multiple CSI-RS or SSB resource identifiers (where each CSI-RS or SSB resource identifier is associated with a different beam direction) and a UE 115 may measure and report an L1-RSRP for each of the multiple CSI-RS or SSB resource identifiers. The network entity 105 or the UE 115 may use a time series of L1-RSRP measurements or reports as an input into a model (e.g., an artificial intelligence or machine learning model) and may obtain, as an output of the model, one or more targets, predictions, or estimations associated with beam management between the UE 115 and the network entity 105. In implementations in which the prediction is performed at the network entity 105, the network entity 105 may use L1-RSRPs reported by the UE 115 as inputs into the model. In implementations in which the prediction is performed at the UE 115, the UE 115 may use L1-RSRPs measured by the UE 115. In either or both implementations, the model input may thus depend on for which beams the UE 115 measures or reports an L1-RSRP. The one or more targets obtained as an output of the model may include a first target associated with predicting (future) L1-RSRPs, a second target associated with predicting candidate beam(s), or a third target associated with predicting beam failure or blockage. As described herein, such artificial intelligence or machine learning based beam management may reduce UE power consumption, reduce UE specific reference signal overheard, reduce latency, or increase throughput, or any combination thereof.

In an example of spatial domain beam prediction, one or more devices may support explicit spatial domain beam prediction or implicit spatial domain beam prediction. For explicit spatial domain beam prediction, a UE 115 or a network entity 105 may predict L1-RSRPs of a first group of beams based on measured or reported L1-RSRPs of a second group of beams. For example, in implementations in which the prediction is performed at the UE 115, the UE 115 may input L1-RSRPs of the second group of beams measured by the UE 115 into a model and may obtain, as an output of the model, predicted, expected, or estimated L1-RSRPs of the first group of beams. In implementations in which the prediction is performed at the network entity 105, the network entity 105 may input L1-RSRPs of the second group of beams reported by the UE 115 into a model and may obtain, as an output of the model, predicted, expected, or estimated L1-RSRPs of the first group of beams. In either or both implementations, the model input may thus depend on for which beams the UE 115 measures or reports an L1-RSRP. Suh explicit spatial domain beam prediction may be associated with a reduced quantity of beams measured by the UE 115, which may reduce power consumption at the UE 115.

For implicit spatial domain beam prediction, a UE 115 or a network entity 105 may predict beam pointing direction(s) and corresponding L1-RSRPs based on (e.g., defined by) a linear combination of a group of beams or based on more explicit direction and L1-RSRP prediction. For example, in implementations in which the prediction is performed at the UE 115, the UE 115 may input information associated with a channel or L1-RSRPs measured by the UE 115 with respect to a group of beams into a model and may obtain, as an output of the model, a beam pointing direction and L1-RSRP predictions. In implementations in which the prediction is performed at the network entity 105, the network entity 105 may input information associated with a channel or L1-RSRPs reported by the UE 115 with respect to a group of beams into a model and may obtain, as an output of the model, a beam pointing direction and L1-RSRP predictions. In either or both implementations, the model input may thus depend on for which beams the UE 115 measures or reports an L1-RSRP. Suh implicit spatial domain beam prediction may be associated with a greater beam management accuracy without excessive beam sweeping at either or both of the UE 115 or the network entity 105.

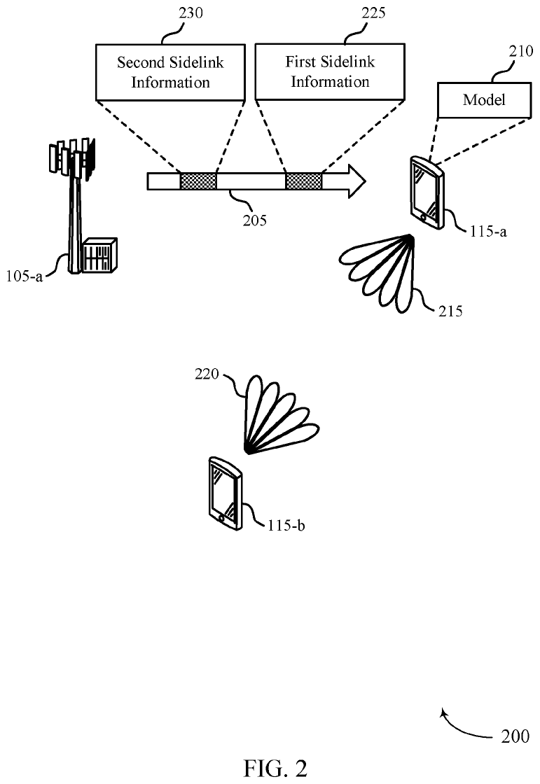

In some implementations, and as described herein with reference to FIG. 2, a network entity 105 and at least a first UE 115 may support a signaling mechanism that enables the first UE 115 to predict one or more directional beams for sidelink communication between the first UE 115 and a second UE 115 in accordance with sidelink information associated with one or both of the first UE 115 and the second UE 115. For example, the network entity 105 may transmit, to the first UE 115, sidelink information (which may include location information, mobility information, channel profile information, or any combination thereof) associated with one or both of the first UE 115 and the second UE 115 and the first UE 115 may use the sidelink information to predict a set of one or more directional beams. In some implementations, the first UE 115 may use the set of one or more directional beams to transmit or receive one or more sidelink SSBs to or from the second UE 115. Additionally, or alternatively the first UE 115 may use the set of one or more directional beams to communicate a sidelink data message with the second UE 115 (e.g., to transmit or receive the sidelink data message to or from the second UE 115). In some implementations, the first UE 115 may use a model, such as a machine learning or an artificial intelligence model, to predict the one or more directional beams. Further, in some implementations, the signaling mechanism may include beam reporting to the network entity 105 from the first UE 115 and beam confirmation or reversion signaling from the network entity 105 to the first UE 115.

FIG. 2 illustrates an example of a signaling diagram 200 that supports machine learning based predictive initial beam pairing for sidelink in accordance with one or more aspects of the present disclosure. The signaling diagram 200 may implement or be implemented to realize aspects of the wireless communications system 100. For example, the signaling diagram 200 illustrates communication between a network entity 105-a, a UE 115-a, and a UE 115-b, each of which may be examples of corresponding devices as illustrated by and described herein with reference to FIG. 1. Further, the network entity 105-b may be an example of a gNB, a base station 140, or another network entity or functionality, such as an LMF. In some implementations, the network entity 105-a and at least the UE 115-a may support a signaling mechanism that facilitates use of a learning model (e.g., a machine learning model or an artificial intelligence model) at the UE 115-a for predicting one or more directional beams to use for communication with the UE 115-b.

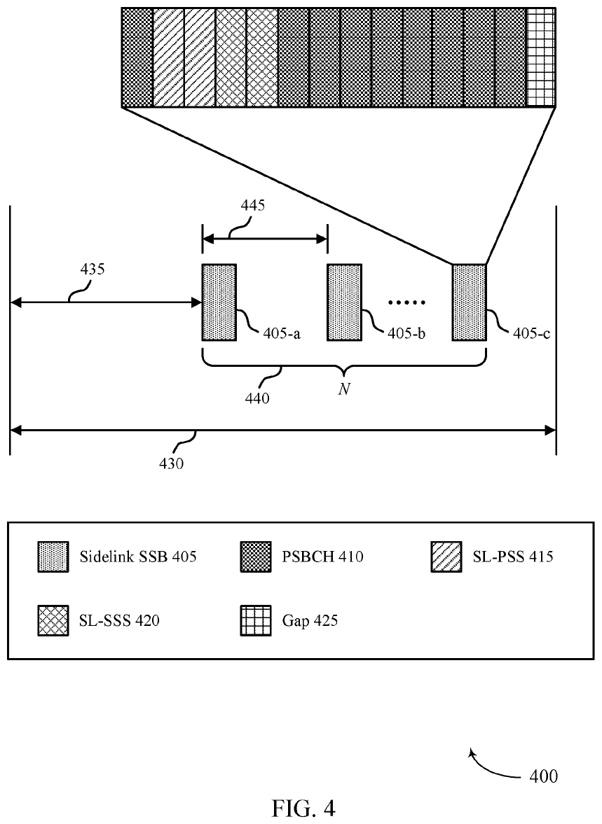

For example, in scenarios in which the UE 115-a and the UE 115-b lack a configured beam pair (e.g., have not established a wireless connection), the UE 115-a and the UE 115-b may perform one or more procedures associated with initial beam pairing in sidelink. In some scenarios (e.g., in-coverage scenarios, such is if the UE 115-a is operating in accordance with a sidelink mode 1 with the network entity 105-a), initial beam pairing may be challenging (e.g., in terms of resource usage or power consumption, or both). For example, and as illustrated by and described herein with reference to FIG. 4, initial beam pairing may include transmission or reception of up to 64 repeated SSBs per period, where repetition may be with respect to a payload (e.g., not a transmit beam) and cross-SSB transmit beams may be the same or may be different. Further, initial sidelink beam pairing may lack analog SSB-to-RACH associations (as may be supported for Uu link initial beam pairing) and consistency of a beam pattern across SSB periods may be difficult due to UE mobility.

In some systems, the network entity 105-a may support the initial beam pairing between the UE 115-a and the UE 115-b. For example, SSB transmission may be on-demand and may be negotiated by the network entity 105-a. In such examples, the UE 115-a may receive an indication of an SSB beam repetition pattern from the network entity 105-a and the UE 115-b may report a preferred transmit beam (e.g., a best beam or a beam that provides a suitable signal strength or link quality) to the network entity 105-a in accordance with SSB reception at the UE 115-b. The UE 115-a and the UE 115-b may receive further indications from the network entity 105-a, such as indications on which transmit or receive beams to use for transmission or reception of a sidelink data message, such as a physical sidelink shared channel (PSSCH) transmission or reception.

In some cases, a latency associated with successful initial sidelink beam pairing between the UE 115-a and the UE 115-b may be highly dependent on a choice of a one or more transmit beams and one or more receive beams by the UE 115-a and the UE 115-b. For example, without prior knowledge or information, the UE 115-a or the UE 115-b, or both, may determine transmit or receive beams arbitrarily (e.g., via one or more beam sweeping procedures). Further, although the network entity 105-a may regulate a transmit beam repetition pattern at the UE 115-a and signal this pattern to the UE 115-b, which metric(s) to use in the determination of the pattern may be unclear or ambiguous at the network entity 105-a.

In some aspects, sidelink information (which may be equivalently referred to as side information) may assist the UE 115-a or the UE 115-b, or both, in selecting respective transmit or receive beams. Such sidelink information may include location information of one or both of the UE 115-a or the UE 115-b or mobility information of one or both of the UE 115-a or the UE 115-b. Additionally, or alternatively, such sidelink information may include a respective channel profile of one or both of the UE 115-a or the UE 115-b. Such a channel profile of the UE 115-a may be associated with a channel between the UE 115-a and the network entity 105-a or a channel between the UE 115-a and a third UE 115 (not shown). Similarly, such a channel profile of the UE 115-b may be associated with a channel between the UE 115-b and the network entity 105-b or a channel between the UE 115-b and a fourth UE 115 (not shown). In some aspects, a channel profile may include information associated with a power delay profile (PDP), an angle of attack (AoA), and angle of departure (AoD), or a raw-channel metric, among other examples of measurements or metrics associated with a given channel. Additionally, or alternatively, such sidelink information may include a transmit beam repetition pattern of the UE 115-a (to help the UE 115-b determine one or more receive beams) or a receive beam repetition pattern of the UE 115-b (to help the UE 115-a determine one or more transmit beams).

The assistance that such sidelink information provides to one or both of the UE 115-a and the UE 115-b, however, may be insufficient in some deployment scenarios. For example, beam determination may not be straightforwardly derived via some statistical signal processing schemes in some deployment scenarios (e.g., deployment scenarios associated with frequently changing channel conditions or high mobility). In such deployment scenarios, artificial intelligence or machine learning based beam prediction methods may achieve greater beam selection accuracy with lower overhead at one or both of the UE 115-a and the UE 115-b.

In some implementations, at least the UE 115-a may input sidelink information received from the network entity 105-a via a communication link 205 into a model 210 and may obtain, as an output of the model 210, an indication of one or more directional beams 215 (e.g., transmit or receive beams). The UE 115-a may support reinforcement learning to train the model 210 and may use the model 210 to predict the one or more directional beams 215 for sidelink SSB transmission, sidelink SSB reception, PSSCH transmission, or PSSCH reception. In implementations in which the UE 115-a uses the model 210 to predict one or more directional beams 215 for PSSCH transmission or reception, the UE 115-a may additionally input information associated with sidelink SSB transmission or reception into the model 210. To support use of the model 210 for predicting the one or more directional beams 215, the network entity 105-a and at least the UE 115-a may support a signaling mechanism to enable such features of the model 210 (e.g., to enable machine learning based sidelink predictive initial beam pairing).

The UE 115-a may be deployed with the model (e.g., an artificial intelligence model, a machine learning model, or another reinforcement learning model), to carry out time or spatial domain beam or channel characteristics for sidelink communications, for predicting transmit or receive beams and associated repetition parameters during initial sidelink beam pairing procedures across various use cases. In some use cases, the UE 115-a may use the model 210 to predict one or more directional beams 215 and associated repetition patterns for a sidelink SSB. In such use cases, the one or more directional beams 215 may be examples of transmit beams if the UE 115-a is to transmit the sidelink SSB or may be examples of receive beams if the UE 115-a is to receive the sidelink SSB. Additionally, or alternatively, the UE 115-a may use the model 210 to predict a directional beam 215 for PSSCH transmission or reception. For example, the UE 115-a (which may transmit a sidelink SSB or receive a sidelink SSB) may use the model to predict a transmit beam or a receive beam for PSSCH transmission or PSSCH reception.

In use cases in which the UE 115-a uses the model 210 to predict one or more directional beams 215 and associated repetition patterns for a sidelink SSB, the UE 115-a may input, into the model 210, first sidelink information 225. In some implementations, for example, the UE 115-a may receive the first sidelink information 225 from the network entity 105-a (via the communication link 205) and may input the first sidelink information 225 into the model 210. As such, the model 210 may use or process the first sidelink information 225 and output an indication of the one or more directional beams 215 and the associated repetition patterns for the sidelink SSB. In some aspects, sidelink SSB transmission or reception may be associated with one or more sidelink SSB occasions, as described herein with reference to FIG. 4. The first sidelink information 225 may include location information of the UE 115-b, mobility information of the UE 115-b, a first channel profile of a first link between the UE 115-a and the network entity 105-a, a second channel profile of a second link between the UE 115-b and the network entity 105-a, a third channel profile of a third link between the UE 115-b and a third UE 115 (not shown) and location information of the third UE 115, or any combination thereof.

In use cases in which the UE 115-a uses the model 210 to predict a directional beam 215 for PSSCH transmission or reception, the UE 115-a may input, into the model 210, second sidelink information 230. In some implementations, for example, the UE 115-a may receive the second sidelink information 230 from the network entity 105-a (via the communication link 205) and may input the second sidelink information 230 into the model 210. As such, the model 210 may use or process the second sidelink information 230 and output an indication of the directional beam 215 for the PSSCH transmission or reception. The second sidelink information 230 may include an RSRP associated with at least one sidelink SSB, one or more directional beams (e.g., transmit or receive beams) and one or more beam repetition patterns used by the UE 115-b, the first sidelink information 225, or any combination thereof.

Further, although described herein with reference to FIG. 2 in the context of the UE 115-a, the UE 115-b may additionally, or alternatively, support a similar model 210 and use the model 210 to predict or determine a set of directional beams 220 that the UE 115-b may use to transmit or receive a set of sidelink SSBs to or from the UE 115-a or to transmit or receive a sidelink data message (e.g., a PSSCH) to or from the UE 115-a. As such, one or both of the UE 115-a and the UE 115-b may support a model 210 (e.g., an artificial intelligence or machine learning model) and associated signaling mechanism to support predictive beam pairing for sidelink.

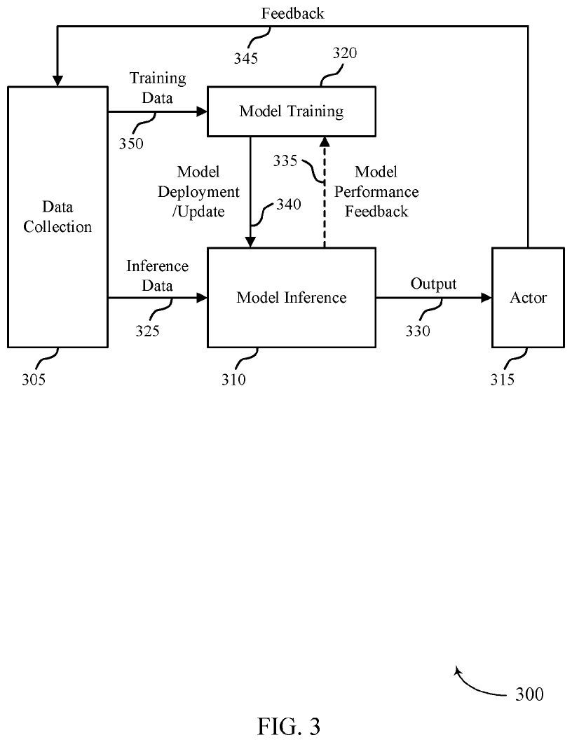

FIG. 3 illustrates an example of a learning model 300 that supports machine learning based predictive initial beam pairing for sidelink in accordance with one or more aspects of the present disclosure. The learning model 300 may implement or be implemented to realize aspects of the wireless communications system 100 or the signaling diagram 200. For example, a first UE 115 (e.g., the UE 115-a as illustrated by and described herein with reference to FIG. 2) may implement the learning model 300 to predict one or more directional beams 215 for sidelink SSB transmission, sidelink SSB reception, PSSCH transmission, or PSSCH reception, or any combination thereof. In some aspects, the learning model 300 may be associated with data collection for NR and evolved-universal terrestrial radio access network (E-UTRAN) NR-dual connectivity (EN-DC) (e.g., functional frameworks).

In some implementations, the first UE 115 may receive an indication or configuration information associated with the learning model 300 from a network entity 105 (e.g., the network entity 105-a as illustrated by and described herein with reference to FIG. 2). For example, the first UE 115 may receive one or more parameters or weightings associated with the learning model 300 from the network entity 105. In such implementations, the network may train the learning model 300 or may receive an indication of one or more trained (intermediate) models from one or more other UEs 115 (and generate the learning model 300 based on the received trained models). Additionally, or alternatively, the first UE 115 may be preloaded (in hardware or software) with the learning model 300 and may train the learning model 300 in accordance with independent UE decision or implementation.

The learning model 300 may include a data collection function 305, a model inference function 310, an actor function 315, and a model training function 320. The data collection function 305 may be a function that provides input data to the model training function 320 and the model inference function 310. Artificial intelligence or machine learning algorithm specific data preparation (e.g., data pre-processing and cleaning, formatting, and transformation) may not be carried out in the data collection function 305. Examples of input data may include measurements from one or more UEs 115 or different network entities 105, feedback from the actor function 315, or outputs from another model (e.g., another artificial intelligence or machine learning model). For example, the data collection function 305 may output training data 350 to the model training function 320 and the training data 350 may include data to be used as an input for the model training function 320 (e.g., an artificial intelligence or machine learning model training function). The data collection function 305 may output inference data 325 to the model inference function 310 and the inference data 325 may include data to be used as an input for the model inference function 310 (e.g., an artificial intelligence or machine learning model inference function).

The model training function 320 may be a function that performs the machine learning model training, validation, and testing, which may generate model performance metrics as part of a model testing procedure. The model training function 320 may also be responsible for data preparation (e.g., data pre-processing and cleaning, formatting, and transformation) based on the training data 350 delivered by the data collection function 305, if expected to. The model training function 320 may output model deployment/update information 340 to the model inference function 310 and the model deployment/update information 340 may be used to initially deploy a trained, validated, and tested artificial intelligence or machine learning model to the model inference function 310 or to deliver an updated model to the model inference function 310. The model training function 320 may be associated with a single-vendor environment or a multi-vendor environment.

The model inference function 310 may be a function that provides artificial intelligence or machine learning model inference output (e.g., predictions or decisions). The model inference function 310 may, in some implementations, provide model performance feedback 335 to the model training function 320. The model inference function 310 may also be responsible for data preparation (e.g., data pre-processing and cleaning, formatting, and transformation) based on the inference data 325 delivered by the data collection function 305, if expected to. The output 330 may be the inference output of the artificial intelligence or machine learning model produced by the model inference function 310 and a content of the inference output may be use case specific. In some implementations, the model performance feedback 335 may be applied if some information derived from the model inference function 310 is suitable for improvement of the artificial intelligence or machine learning model trained in the model training function 320. Feedback 345 from the actor function 315 or other network entities (via the data collection function 305) may be used at the model inference function 310 to create the model performance feedback 335.

The actor function 315 may be a function that receives the output 330 from the model inference function 310 and triggers or performs corresponding actions. The actor function 315 may trigger actions directed to other entities or to itself. In some aspects, the actor function 315 may provide the feedback 345 to the data collection function 305 and the feedback 345 may include information that may be used to derive training or inference data or performance feedback.

FIG. 4 illustrates an example of a communication timeline 400 that supports machine learning based predictive initial beam pairing for sidelink in accordance with one or more aspects of the present disclosure. The communication timeline 400 may implement or be implemented to realize aspects of the wireless communications system 100, the signaling diagram 200, or the learning model 300. For example, the communication timeline 400 illustrates an SSB signaling timeline (e.g., a sidelink SSB signaling timeline). As such, a first UE 115 (e.g., the UE 115-a as illustrated by and described herein with reference to FIG. 2) may transmit or receive one or more sidelink SSBs 405 to a second UE 115 (e.g., the UE 115-b as illustrated by and described herein with reference to FIG. 2) using one or more directional beams 215 that the first UE 115 identifies, selects, or otherwise predicts via an output of a model (e.g., the model 210 as illustrated by and described herein with reference to FIG. 2).

The communication timeline 400 may illustrate transmission or reception of a set of sidelink SSBs 405 including a sidelink SSB 405-a, a sidelink SSB 405-b, and a sidelink SSB 405-c. Each sidelink SSB 405 (and as specifically shown in the context of the sidelink SSB 405-c) may include a set of symbol periods and may allocate the symbol periods to a physical sidelink broadcast channel (PSBCH) 410, a sidelink primary synchronization signal (SL-PSS) 415, a sidelink secondary synchronization signal (SL-SSS) 420, and a gap 425. The set of sidelink SSBs 405 may be associated with a sidelink SSB periodicity 430. In some aspects, the sidelink SSB periodicity 430 may be equal to approximately 160 milliseconds. The sidelink SSBs 405 may be further associated with a time offset 435 (e.g., as defined by an sl-TimeOffsetSSB parameter) and, in some aspects, the time offset 435 may be between 0-1279 slots. The sidelink SSBs 405 may be further associated with a period 440, which may be defined by N=1, 2, . . . , 64 and defined by an sl-numSSB-WithinPeriod parameter. The sidelink SSBs 405 may be further associated with a time interval 445 that defines a time gap between each of the sidelink SSBs 405. In some aspects, the time interval 445 may be defined by an sl-TimeInterval parameter and may be between 0-639 slots.

In some implementations, within a given sidelink SSB occasion, one or more transmit beams may be separated into multiple repetition sub-occasion groups. For example, (e.g., for transmit beams and corresponding repetition patterns), each sub-occasion group (e.g., each sub-transmit-occasion group) may include one or multiple sub-occasions and the first UE may use a same directional beam (e.g., a same transmit beam) during each sub-occasion and may use different directional beams in different sub-occasion groups (e.g., different sub-transmit-occasion groups). In other words, different sub-occasion groups may be assumed to include SSB transmissions by different transmit beams. In some implementations, transmit beams may be explicitly defined based on a panel identifier or a beam identifier, or both, of the first UE 115 and the first UE 115 may pre-report a mapping or association between transmit beams and panel or beam identifiers to the network entity 105 or a machine learning server. Transmit beams and repetition patterns may be defined based on a sub-occasion grouping pattern (and optionally based on the explicitly defined transmit beam information of the first UE 115). The associations between the beams and repetition pattern and corresponding identifiers may be subject to an agreement or coordination between two or more of the network entity 105, the first UE 115, or the second UE 115 and may be based on further configurations by the network entity 105.

For receive beams and corresponding repetition patterns, receive beams may be defined based on a panel identifier or a beam identifier, or both, of the first UE 115 and the first UE 115 may pre-report a mapping or association between receive beams and panel or beam identifiers to the network entity 105 or a machine learning server. The receive beams and repetition patterns may be defined based on the receive beams used within a specific sub-occasion (e.g., within a specific sub-transmit-occasion) and across different sub-occasions (e.g., different sub-transmit-occasions) and optionally based on the explicitly defined receive beam information from the first UE 115. For example, within a given sub-occasion, the first UE 115 may use a same receive beam or different receive beams and, across different sub-occasions, the first UE 115 may use a same receive beam pattern or different receive beam patterns. The associations between receive beams and receive beam repetition patterns and corresponding identifiers may be subject to an agreement or coordination between two or more of the network entity 105, the first UE 115, or the second UE 115 and may be based on further configurations by the network entity 105.

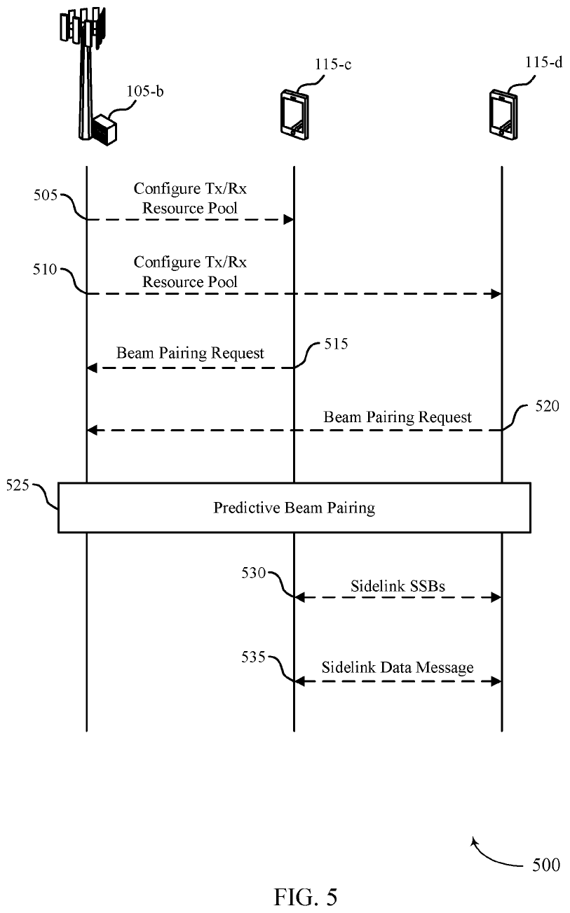

FIG. 5 illustrates an example of a process flow 500 that supports machine learning based predictive initial beam pairing for sidelink in accordance with one or more aspects of the present disclosure. The process flow 500 may implement or be implemented to realize aspects of the wireless communications system 100, the signaling diagram 200, the learning model 300, or the communication timeline 400. For example, the process flow 500 illustrates communication between a network entity 105-b, a UE 115-c, and a UE 115-d, each of which may be examples of corresponding devices described herein. Further, the network entity 105-b may be an example of a gNB, a base station 140, or another network entity or functionality, such as an LMF. In some implementations, the network entity 105-b and at least one of the UE 115-c and the UE 115-d may support a signaling mechanism that enables use of a model (such as a model 210 as illustrated by and described herein with reference to FIG. 2) to predict one or more of a set of sidelink SSB transmit beams, a set of sidelink SSB receive beams, a PSSCH transmit beam, or a PSSCH receive beam.

In the following description of the process flow 500, the operations may be performed (such as reported or provided) in a different order than the order shown, or the operations performed by the example devices may be performed in different orders or at different times. For example, specific operations also may be left out of the process flow 500, or other operations may be added to the process flow 500. Further, although some operations or signaling may be shown to occur at different times for discussion purposes, these operations may actually occur at the same time.

At 505, the network entity 105-b may configure a transmit resource pool or a receive resource pool at the UE 115-c that the UE 115-c may use for transmitting or receiving one or more sidelink SSBs.

At 510, the network entity 105-b may configure a transmit resource pool or a receive resource pool at the UE 115-d that the UE 115-d may use for transmitting or receiving one or more sidelink SSBs.

At 515, the UE 115-c may transmit a beam pairing request to the network entity 105-b. In some aspects, the UE 115-c may transmit the beam pairing request to the network entity 105-b to request the network entity 105-b to assist the UE 115-c in establishing a beam pair link between the UE 115-c and the UE 115-d.

At 520, the UE 115-d may transmit a beam pairing request to the network entity 105-b. In some aspects, the UE 115-d may transmit the beam pairing request to the network entity 105-b to request the network entity 105-b to assist the UE 115-d in establishing a beam pair link between the UE 115-c and the UE 115-d.

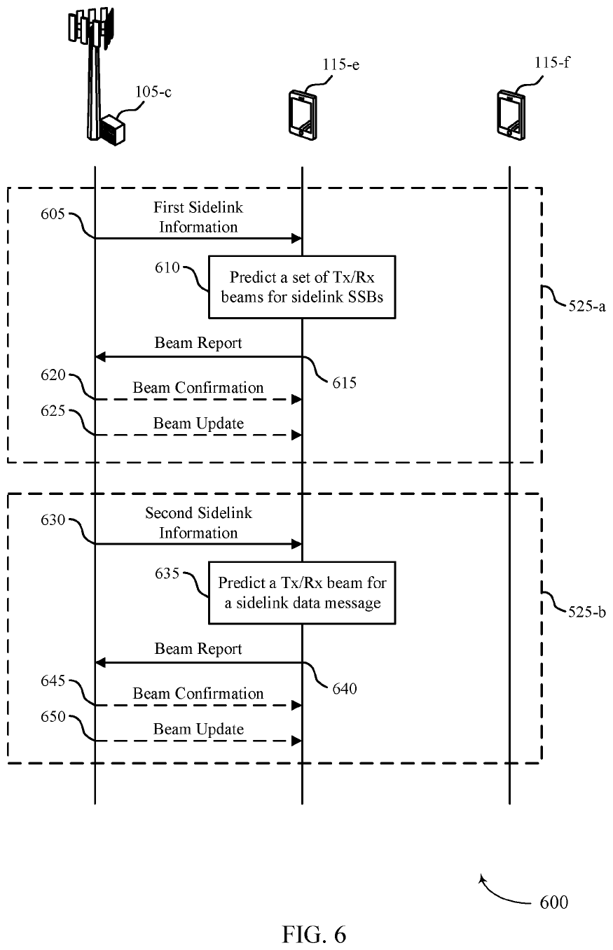

At 525, the network entity 105-b and at least one of the UE 115-c and the UE 115-d may transmit or receive signaling that enables use of a model (such as a model 210 as illustrated by and described herein with reference to FIG. 2) to predict one or more of a set of sidelink SSB transmit beams, a set of sidelink SSB receive beams, a PSSCH transmit beam, or a PSSCH receive beam. Additional details associated with such signaling are illustrated by and described herein with reference to FIG. 6.

In addition, or as an alternative, to exchanging the signaling at 525, the network entity 105-b, the UE 115-c, and the UE 115-d may exchange signaling associated with another sidelink beam pairing procedure. For example, the network entity 105-a may configure or trigger one of the UE 115-c and the UE 115-d for sidelink beam pairing reference signal sweeping as a transmitter and may configure or trigger the other of the UE 115-c and the UE 115-d for sidelink beam pairing reference signal sweeping as a receiver. As such, the UE 115-c or the UE 115-d may perform beam pairing reference signal sweeping in accordance with transmitting a reference signal waveform (e.g., a sidelink CSI-RS, PSS, or SSS, among other example reference signals) and the other of the UE 115-c and the UE 115-d may measure the reference signal transmissions and transmit a beam report to the network entity 105-b. As such, the network entity 105-b may transmit information associated with a beam configuration to the UE 115-c and the UE 115-d and the UE 115-c and the UE 115-d may select directional beams to use for sidelink communication in accordance with the beam configuration.

At 530, the UE 115-c and the UE 115-d may exchange one or more sidelink SSBs in accordance with the predictive beam pairing at 525. In some implementations, for example, the UE 115-c may identify a set of transmit beams as an output of a model (e.g., a model 210) and may use the set of transmit beams to transmit the set of sidelink SSBs to the UE 115-d. In some other implementations, the UE 115-c may identify a set of receive beams as an output of a model (e.g., a model 210) and may use the set of receive beams to receive the set of sidelink SSBs from the UE 115-d.

At 535, the UE 115-c and the UE 115-d may exchange a sidelink data message in accordance with the predictive beam pairing at 525. In some implementations, for example, the UE 115-c may identify a transmit beam as an output of a model (e.g., a model 210) and may use the transmit beam to transmit the sidelink data message (e.g., a PSSCH message or transmission) to the UE 115-d. In some other implementations, the UE 115-c may identify a receive beam as an output of a model (e.g., a model 210) and may use the receive beam to receive the sidelink data message (e.g., a PSSCH message or reception) from the UE 115-d.

FIG. 6 illustrates an example of a process flow 600 that supports machine learning based predictive initial beam pairing for sidelink in accordance with one or more aspects of the present disclosure. The process flow 600 may implement or be implemented to realize aspects of the wireless communications system 100, the signaling diagram 200, the learning model 300, the communication timeline 400, or the process flow 500. For example, the process flow 600 illustrates communication between a network entity 105-c, a UE 115-e, and a UE 115-f, each of which may be examples of corresponding devices described herein. Further, the network entity 105-c may be an example of a gNB, a base station 140, or another network entity or functionality, such as an LMF. In some implementations, the network entity 105-c and at least one of the UE 115-e and the UE 115-f may support a signaling mechanism that enables use of a model (such as a model 210 as illustrated by and described herein with reference to FIG. 2) to predict one or more of a set of sidelink SSB transmit beams, a set of sidelink SSB receive beams, a PSSCH transmit beam, or a PSSCH receive beam.

In the following description of the process flow 600, the operations may be performed (such as reported or provided) in a different order than the order shown, or the operations performed by the example devices may be performed in different orders or at different times. For example, specific operations also may be left out of the process flow 600, or other operations may be added to the process flow 600. Further, although some operations or signaling may be shown to occur at different times for discussion purposes, these operations may actually occur at the same time.

As illustrated by the process flow 600, the network entity 105-c and at least one of the UE 115-e and the UE 115-f may support a signaling mechanism at one or both of 525-a and 525-b, which may be an example of a signaling mechanism for predictive beam pairing at 525 as illustrated by and described herein with reference to FIG. 5. For example, the signaling at 525-a illustrates an example signaling that may occur at 525 in the process flow 500 and the signaling at 525-b illustrates additional, or alternative, signaling that may occur at 525 in the process flow 500. In some aspects, the signaling at 525-a may be associated with predicting a set of one or more directional beams 215 associated with transmission or reception of a set of sidelink SSBs and the signaling at 525-b may be associated with predicting a directional beam 215 associated with transmission or reception of a sidelink data message (e.g., a PSSCH message).

At 605, the network entity 105-c may transmit, to the UE 115-e (which may be an example of a first UE 115 or the UE 115-a), first sidelink information associated with one or both of the UE 115-e and the UE 115-f. The first sidelink information may include location information associated with the UE 115-f, mobility information associated with the UE 115-f, a channel profile associated with a Uu link between the UE 115-e and the network entity 105-c, a channel profile associated with a Uu link between the UE 115-f and the network entity 105-c, or a channel profile associated with a link between the UE 115-f and another UE 115 (not shown), which may include sidelink PDP, AoA, AoD, and raw-channel information together with location information associated with the other UE 115. In examples in which the UE 115-e is receiving the set of sidelink SSBs, the first sidelink information may further include which transmit beams and transmit beam repetition patterns that the UE 115-f may use to transmit the sidelink SSB. The network entity 105-c may obtain the first sidelink information via any combination of measurement or UE reporting.

At 610, the UE 115-e may predict a set of transmit or receive beams for the set of sidelink SSBs in accordance with inputting the first sidelink information into a model (e.g., a model 210). In implementations in which the UE 115-e is to transmit the set of sidelink SSBs, the UE 115-e may obtain, as an output of the model, at least one of the set of transmit beams to be used within the sidelink SSBs and transmit beam repetition patterns associated with the set of transmit beams. In implementations in which the UE 115-e is to receive the set of sidelink SSBs, the UE 115-e may obtain, as an output of a model (e.g., a model 210), at least one of the set of receive beams to be used within the sidelink SSBs and receive beam repetition patterns associated with the set of receive beams.

At 615, the UE 115-e may transmit, to the network entity 105-c, a beam report including an indication of the set of transmit beams and the set of transmit beam repetition patterns or an indication of the set of receive beams and the set of receive beam repetition patterns that the UE 115-e determined or predicted based on the model (e.g., an artificial intelligence or machine learning model). In some aspects, different transmit or receive beams and different repetition patterns may be indicated by respective identifiers and, in such aspects, the UE 115-e may report such an identifier to indicate a set of transmit or receive beams and a set of repetition parameters. Additionally, or alternatively, multiple sidelink SSB occasions may be considered and different occasions may be indicated by different identifiers. As such, the UE 115-e may report one or more identifiers corresponding to the one or more sidelink SSB occasions to be transmitted or received or that otherwise correspond to the determined set of transmit or receive beams and repetition patterns. In some implementations, the network entity 105-c may transmit this information to the UE 115-f to assist the UE 115-f in selecting directional beams for transmitting or receiving the set of sidelink SSBs.

The initiation of the reporting of the predicted transmit or receive beams and repetition patterns may be by the network entity 105-c or the UE 115-e. In some implementations, for example, the network entity 105-c may signal the UE 115-e regarding model input information and the network entity 105-c may further trigger (such as via a request for a report) the UE 115-e to report the transmit or receive beams and repetition patterns that the UE 115-e determines based on the model output. Additionally, or alternatively, the UE 115-e may proactively determine to request model input information from the network entity 105-c and may further request to report the transmit or receive beams and repetition patterns that the UE 115-e determines based on the model output.

At 620, the network entity 105-c may transmit, to the UE 115-e, a confirmation of the transmit or receive beams and repetition patterns that the UE 115-e reported to the network entity 105-c at 615. As such, the UE 115-e may transmit or receive the set of sidelink SSBs using the set of transmit or receive beams and repetition patterns that the UE 115-e determined as an output of the model.

At 625, the network entity 105-c may alternatively transmit, to the UE 115-e, a beam update message including an indication of an alternative set of transmit or receive beams and repetition patterns based on receiving the beam report at 615. Such a beam update message may be equivalently referred to as a beam reversion message to revert the beam selection for the sidelink SSB transmission or reception procedure. As such, the UE 115-e may transmit or receive the set of sidelink SSBs using the alternative set of transmit or receive beams and repetition patterns that the network entity 105-c indicated to the UE 115-e.

At 630, the network entity 105-c may transmit, to the UE 115-e, second sidelink information associated with one or both of the UE 115-e and the UE 115-f. The second sidelink information may include one or more L1-RSRPs associated with one or multiple of the set of sidelink SSBs (e.g., associated with one or multiple sidelink SSB sub-occasions), a set of transmit or receive beams and repetition patterns used by the UE 115-f during the sidelink SSB transmission procedure, a transmit or receive beam that the UE 115-f is to use for PSSCH transmission or reception, or other information that may be conveyed via the first sidelink information. The network entity 105-c may obtain the second sidelink information via any combination of measurement or UE reporting. For example, the network entity 105-c may obtain measurement information associated with the set of sidelink SSBs from the UE 115-e or the UE 115-f (e.g., whichever UE 115 receives and measures the set of sidelink SSBs) and may convey that measurement information via the second sidelink information.

At 635, the UE 115-e may predict a transmit or receive beam for a sidelink data message (e.g., a PSSCH) in accordance with inputting the second sidelink information into a model (e.g., a model 210). In implementations in which the UE 115-e is to transmit the sidelink data message, the UE 115-e may obtain, as an output of the model, a transmit beam that the UE 115-e may use for transmitting the sidelink data message to the UE 115-f. In such implementations, the transmit beam may be one of the transmit or receive beams used for the sidelink SSB transmission or may be a transmit beam different from any of the transmit or receive beams used in the sidelink SSB transmission (e.g., due to mobility of the UE 115-e or the UE 115-f). In implementations in which the UE 115-e is to receive the sidelink data message, the UE 115-e may obtain, as an output of the model, a receive beam that the UE 115-e may use for receiving the sidelink data message from the UE 115-f. In such implementations, the receive beam may be one of the transmit or receive beams used in the sidelink SSB transmission or may be a receive beam different from any of the transmit or receive beams used in the sidelink SSB transmission (e.g., due to mobility of the UE 115-e or the UE 115-f).

At 640, the UE 115-e may transmit, to the network entity 105-c, a beam report including an indication of the transmit or receive beam that the UE 115-e predicted or otherwise determined as an output of the model. An initiation of the reporting of the predicted transmit or receive beam may be by the network entity 105-c or the UE 115-e. In some implementations, for example, the network entity 105-c may signal the UE 115-e regarding model input information and the network entity 105-c may further trigger (such as via a request for a report) the UE 115-e to report the transmit or receive beam that the UE 115-e determines based on the model output. Additionally, or alternatively, the UE 115-e may proactively determine to request model input information from the network entity 105-c and may further request to report the transmit or receive beam that the UE 115-e determines based on the model output.

At 645, the network entity 105-c may transmit, to the UE 115-e, a confirmation of the transmit or receive beam that the UE 115-e reported to the network entity 105-c at 640. As such, the UE 115-e may transmit or receive the sidelink data message (e.g., the PSSCH) using the transmit or receive beam that the UE 115-e determined as an output of the model.

At 650, the network entity 105-c may alternatively transmit, to the UE 115-e, a beam update message including an indication of an alternative transmit or receive beam based on receiving the beam report at 640. Such a beam update message may be equivalently referred to as a beam reversion message to revert the beam selection for the PSSCH transmission or reception. As such, the UE 115-e may transmit or receive the sidelink data message (e.g., the PSSCH) using the alternative transmit or receive beam that the network entity 105-c indicated to the UE 115-e.

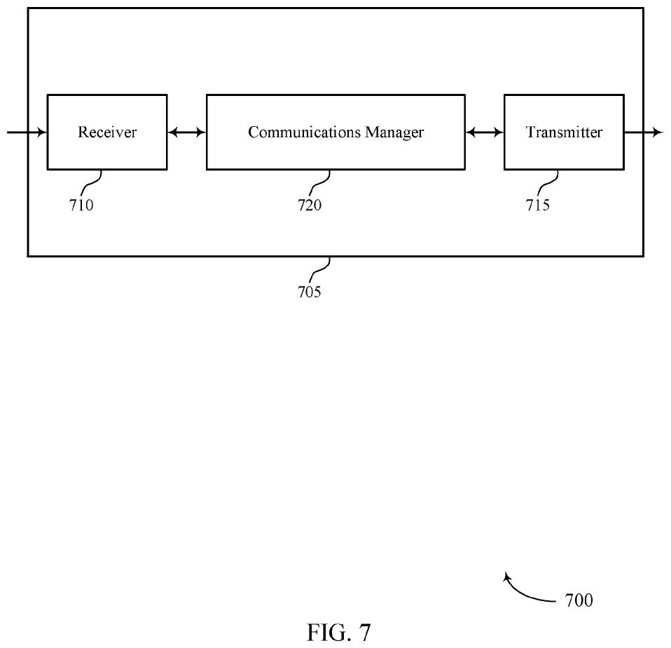

FIG. 7 shows a block diagram 700 of a device 705 that supports machine learning based predictive initial beam pairing for sidelink in accordance with one or more aspects of the present disclosure. The device 705 may be an example of aspects of a UE 115 as described herein. The device 705 may include a receiver 710, a transmitter 715, and a communications manager 720. The device 705 may also include a processor (not shown). Each of these components may be in communication with one another (e.g., via one or more buses).

The receiver 710 may provide a means for receiving information such as packets, user data, control information, or any combination thereof associated with various information channels (e.g., control channels, data channels, information channels related to machine learning based predictive initial beam pairing for sidelink). Information may be passed on to other components of the device 705. The receiver 710 may utilize a single antenna or a set of multiple antennas.

The transmitter 715 may provide a means for transmitting signals generated by other components of the device 705. For example, the transmitter 715 may transmit information such as packets, user data, control information, or any combination thereof associated with various information channels (e.g., control channels, data channels, information channels related to machine learning based predictive initial beam pairing for sidelink). In some examples, the transmitter 715 may be co-located with a receiver 710 in a transceiver module. The transmitter 715 may utilize a single antenna or a set of multiple antennas.

The communications manager 720, the receiver 710, the transmitter 715, or various combinations thereof or various components thereof may be examples of means for performing various aspects of machine learning based predictive initial beam pairing for sidelink as described herein. For example, the communications manager 720, the receiver 710, the transmitter 715, or various combinations or components thereof may support a method for performing one or more of the functions described herein.

In some examples, the communications manager 720, the receiver 710, the transmitter 715, or various combinations or components thereof may be implemented in hardware (e.g., in communications management circuitry). The hardware may include a processor, a digital signal processor (DSP), a central processing unit (CPU), an application-specific integrated circuit (ASIC), a field-programmable gate array (FPGA) or other programmable logic device, a microcontroller, discrete gate or transistor logic, discrete hardware components, or any combination thereof configured as or otherwise supporting a means for performing the functions described in the present disclosure. In some examples, a processor and memory coupled with the processor may be configured to perform one or more of the functions described herein (e.g., by executing, by the processor, instructions stored in the memory).

Additionally, or alternatively, in some examples, the communications manager 720, the receiver 710, the transmitter 715, or various combinations or components thereof may be implemented in code (e.g., as communications management software or firmware) executed by a processor. If implemented in code executed by a processor, the functions of the communications manager 720, the receiver 710, the transmitter 715, or various combinations or components thereof may be performed by a general-purpose processor, a DSP, a CPU, an ASIC, an FPGA, a microcontroller, or any combination of these or other programmable logic devices (e.g., configured as or otherwise supporting a means for performing the functions described in the present disclosure).

In some examples, the communications manager 720 may be configured to perform various operations (e.g., receiving, obtaining, monitoring, outputting, transmitting) using or otherwise in cooperation with the receiver 710, the transmitter 715, or both. For example, the communications manager 720 may receive information from the receiver 710, send information to the transmitter 715, or be integrated in combination with the receiver 710, the transmitter 715, or both to obtain information, output information, or perform various other operations as described herein.

The communications manager 720 may support wireless communication at a first UE in accordance with examples as disclosed herein. For example, the communications manager 720 may be configured as or otherwise support a means for receiving, from a network entity, first sidelink information associated with the first UE, a second UE, or both. The communications manager 720 may be configured as or otherwise support a means for predicting, by the first UE based on the first sidelink information, a set of transmit beams and a set of transmit beam repetition patterns associated with a set of sidelink SSBs. The communications manager 720 may be configured as or otherwise support a means for transmitting, to the second UE, the set of sidelink SSBs based on the set of transmit beams and the set of transmit beam repetition patterns.

Additionally, or alternatively, the communications manager 720 may support wireless communications at a first UE in accordance with examples as disclosed herein. For example, the communications manager 720 may be configured as or otherwise support a means for receiving, from a network entity, an indication of first sidelink information associated with the first UE, a second UE, or both. The communications manager 720 may be configured as or otherwise support a means for predicting, by the first UE based on the first sidelink information, a set of receive beams and a set of receive beam repetition patterns associated with a set of sidelink SSBs. The communications manager 720 may be configured as or otherwise support a means for receiving, from the second UE, the set of sidelink SSBs based on the set of receive beams and the set of receive beam repetition patterns.

By including or configuring the communications manager 720 in accordance with examples as described herein, the device 705 (e.g., a processor controlling or otherwise coupled with the receiver 710, the transmitter 715, the communications manager 720, or any combination thereof) may support techniques for reduced processing, reduced power consumption, and more efficient utilization of communication resources.

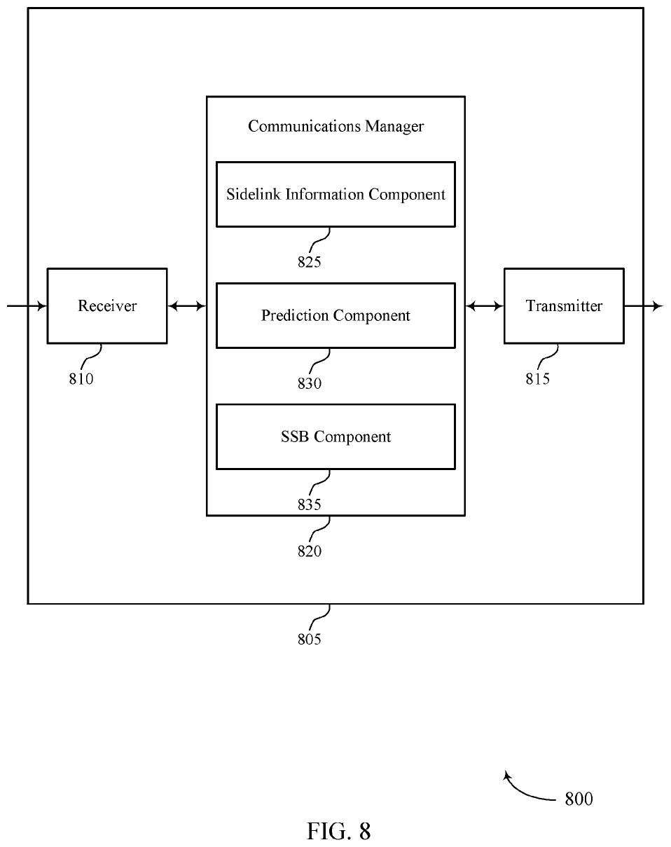

FIG. 8 shows a block diagram 800 of a device 805 that supports machine learning based predictive initial beam pairing for sidelink in accordance with one or more aspects of the present disclosure. The device 805 may be an example of aspects of a device 705 or a UE 115 as described herein. The device 805 may include a receiver 810, a transmitter 815, and a communications manager 820. The device 805 may also include a processor (not shown). Each of these components may be in communication with one another (e.g., via one or more buses).

The receiver 810 may provide a means for receiving information such as packets, user data, control information, or any combination thereof associated with various information channels (e.g., control channels, data channels, information channels related to machine learning based predictive initial beam pairing for sidelink). Information may be passed on to other components of the device 805. The receiver 810 may utilize a single antenna or a set of multiple antennas.

The transmitter 815 may provide a means for transmitting signals generated by other components of the device 805. For example, the transmitter 815 may transmit information such as packets, user data, control information, or any combination thereof associated with various information channels (e.g., control channels, data channels, information channels related to machine learning based predictive initial beam pairing for sidelink). In some examples, the transmitter 815 may be co-located with a receiver 810 in a transceiver module. The transmitter 815 may utilize a single antenna or a set of multiple antennas.

The device 805, or various components thereof, may be an example of means for performing various aspects of machine learning based predictive initial beam pairing for sidelink as described herein. For example, the communications manager 820 may include a sidelink information component 825, a prediction component 830, an SSB component 835, or any combination thereof. The communications manager 820 may be an example of aspects of a communications manager 720 as described herein. In some examples, the communications manager 820, or various components thereof, may be configured to perform various operations (e.g., receiving, obtaining, monitoring, outputting, transmitting) using or otherwise in cooperation with the receiver 810, the transmitter 815, or both. For example, the communications manager 820 may receive information from the receiver 810, send information to the transmitter 815, or be integrated in combination with the receiver 810, the transmitter 815, or both to obtain information, output information, or perform various other operations as described herein.

The communications manager 820 may support wireless communication at a first UE in accordance with examples as disclosed herein. The sidelink information component 825 may be configured as or otherwise support a means for receiving, from a network entity, first sidelink information associated with the first UE, a second UE, or both. The prediction component 830 may be configured as or otherwise support a means for predicting, by the first UE based on the first sidelink information, a set of transmit beams and a set of transmit beam repetition patterns associated with a set of sidelink SSBs. The SSB component 835 may be configured as or otherwise support a means for transmitting, to the second UE, the set of sidelink SSBs based on the set of transmit beams and the set of transmit beam repetition patterns.

Additionally, or alternatively, the communications manager 820 may support wireless communications at a first UE in accordance with examples as disclosed herein. The sidelink information component 825 may be configured as or otherwise support a means for receiving, from a network entity, an indication of first sidelink information associated with the first UE, a second UE, or both. The prediction component 830 may be configured as or otherwise support a means for predicting, by the first UE based on the first sidelink information, a set of receive beams and a set of receive beam repetition patterns associated with a set of sidelink SSBs. The SSB component 835 may be configured as or otherwise support a means for receiving, from the second UE, the set of sidelink SSBs based on the set of receive beams and the set of receive beam repetition patterns.

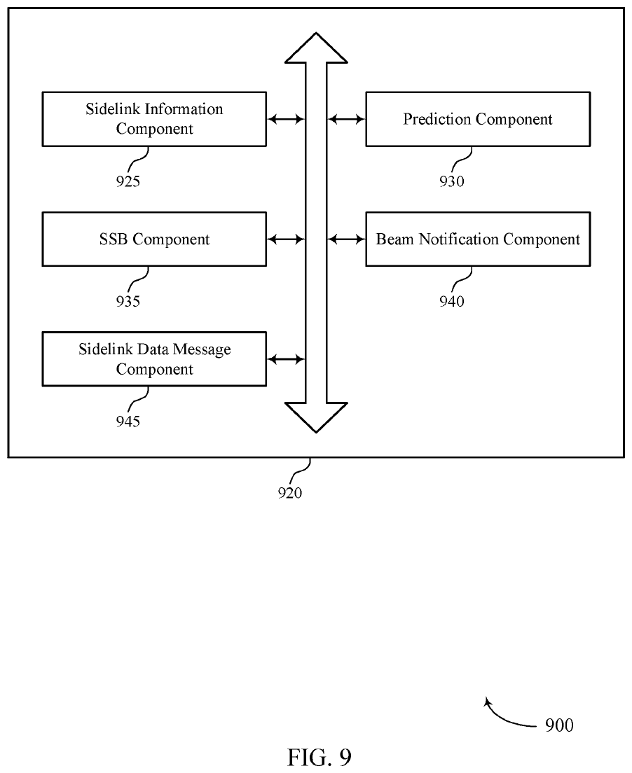

FIG. 9 shows a block diagram 900 of a communications manager 920 that supports machine learning based predictive initial beam pairing for sidelink in accordance with one or more aspects of the present disclosure. The communications manager 920 may be an example of aspects of a communications manager 720, a communications manager 820, or both, as described herein. The communications manager 920, or various components thereof, may be an example of means for performing various aspects of machine learning based predictive initial beam pairing for sidelink as described herein. For example, the communications manager 920 may include a sidelink information component 925, a prediction component 930, an SSB component 935, a beam notification component 940, a sidelink data message component 945, or any combination thereof. Each of these components may communicate, directly or indirectly, with one another (e.g., via one or more buses).

The communications manager 920 may support wireless communication at a first UE in accordance with examples as disclosed herein. The sidelink information component 925 may be configured as or otherwise support a means for receiving, from a network entity, first sidelink information associated with the first UE, a second UE, or both. The prediction component 930 may be configured as or otherwise support a means for predicting, by the first UE based on the first sidelink information, a set of transmit beams and a set of transmit beam repetition patterns associated with a set of sidelink SSBs. The SSB component 935 may be configured as or otherwise support a means for transmitting, to the second UE, the set of sidelink SSBs based on the set of transmit beams and the set of transmit beam repetition patterns.

In some examples, to support predicting the set of transmit beams and the set of transmit beam repetition patterns associated with a set of sidelink SSBs, the prediction component 930 may be configured as or otherwise support a means for inputting the first sidelink information into a model configured to predict one or more transmission characteristics associated with the set of sidelink SSBs. In some examples, to support predicting the set of transmit beams and the set of transmit beam repetition patterns associated with a set of sidelink SSBs, the prediction component 930 may be configured as or otherwise support a means for obtaining, from the model, the set of transmit beams and the set of transmit beam repetition patterns.

In some examples, the beam notification component 940 may be configured as or otherwise support a means for transmitting, to the network entity, an indication of the set of transmit beams and the set of transmit beam repetition patterns.

In some examples, to support transmitting the indication of the set of transmit beams and the set of transmit beam repetition patterns, the beam notification component 940 may be configured as or otherwise support a means for transmitting an identifier associated with the set of transmit beams and the set of transmit beam repetition patterns, where respective pairings of different sets of transmit beams and different sets of transmit beam repetition patterns are associated with a respective identifier of a set of identifiers.

In some examples, the beam notification component 940 may be configured as or otherwise support a means for receiving, from the network entity, a request for the indication of the set of transmit beams and the set of transmit beam repetition patterns, where transmitting the indication of the set of transmit beams and the set of transmit beam repetition patterns is based on receiving the request.

In some examples, the beam notification component 940 may be configured as or otherwise support a means for transmitting, to the network entity, a request to report the indication of the set of transmit beams and the set of transmit beam repetition patterns, where receiving the request for the indication of the set of transmit beams and the set of transmit beam repetition patterns is based on transmitting the request to report the indication of the set of transmit beams and the set of transmit beam repetition patterns.

In some examples, the beam notification component 940 may be configured as or otherwise support a means for receiving, from the network entity, a confirmation of the set of transmit beams and the set of transmit beam repetition patterns, where transmitting the set of sidelink SSBs includes transmitting the set of sidelink SSBs in accordance with the set of transmit beams and the set of transmit beam repetition patterns.

In some examples, the beam notification component 940 may be configured as or otherwise support a means for receiving, from the network entity, an indication of an alternative set of transmit beams and an alternative set of transmit beam repetition patterns, where transmitting the set of sidelink SSBs includes transmitting the set of sidelink SSBs in accordance with the alternative set of transmit beams and the alternative set of transmit beam repetition patterns.

In some examples, the sidelink information component 925 may be configured as or otherwise support a means for transmitting, to the network entity, a request for the first sidelink information, where receiving the first sidelink information is based on transmitting the request.

In some examples, the first sidelink information includes location information of the second UE, mobility information of the second UE, a first channel profile of a first link between the first UE and the network entity, a second channel profile of a second link between the second UE and the network entity, a third channel profile of a third link between the second UE and a third UE and location information of the third UE, or any combination thereof.

In some examples, the set of transmit beams and the set of transmit beam repetition patterns are associated with a set of sidelink SSB occasions. In some examples, each sidelink SSB occasion of the set of sidelink SSB occasions includes a sub-occasion group of one or more sub-occasions. In some examples, each sub-occasion of a given sub-occasion group is associated with a same transmit beam. In some examples, different sub-occasion groups are associated with different transmit beams.

In some examples, the sidelink information component 925 may be configured as or otherwise support a means for receiving, from the network entity, second sidelink information associated with the first UE, the second UE, or both. In some examples, the prediction component 930 may be configured as or otherwise support a means for predicting, by the first UE based on the second sidelink information, a directional beam associated with a sidelink data message. In some examples, the sidelink data message component 945 may be configured as or otherwise support a means for communicating the sidelink data message with the second UE based on the directional beam.

In some examples, to support predicting the directional beam associated with the sidelink data message, the prediction component 930 may be configured as or otherwise support a means for inputting the second sidelink information into a model configured to predict one or more communication characteristics associated with the sidelink data message. In some examples, to support predicting the directional beam associated with the sidelink data message, the prediction component 930 may be configured as or otherwise support a means for obtaining, from the model, the directional beam.

In some examples, the beam notification component 940 may be configured as or otherwise support a means for transmitting, to the network entity, an indication of the directional beam.

In some examples, the beam notification component 940 may be configured as or otherwise support a means for receiving, from the network entity, a request for the indication of the directional beam, where communicating the indication of the directional beam is based on receiving the request.

In some examples, the beam notification component 940 may be configured as or otherwise support a means for transmitting, to the network entity, a request to report the indication of the directional beam, where receiving the request for the indication of the directional beam is based on transmitting the request to report the indication of the directional beam.

In some examples, the beam notification component 940 may be configured as or otherwise support a means for receiving, from the network entity, a confirmation of the directional beam, where communicating the sidelink data message includes transmitting or receiving the sidelink data message using the directional beam.

In some examples, the beam notification component 940 may be configured as or otherwise support a means for receiving, from the network entity, an indication of an alternative directional beam, where communicating the sidelink data message includes transmitting or receiving the sidelink data message using the alternative directional beam.

In some examples, the second sidelink information includes a reference signal receive power associated with at least one of the set of sidelink SSBs, one or more receive beams and one or more receive beam repetition patterns used by the second UE, the first sidelink information, or any combination thereof.

Additionally, or alternatively, the communications manager 920 may support wireless communications at a first UE in accordance with examples as disclosed herein. In some examples, the sidelink information component 925 may be configured as or otherwise support a means for receiving, from a network entity, an indication of first sidelink information associated with the first UE, a second UE, or both. In some examples, the prediction component 930 may be configured as or otherwise support a means for predicting, by the first UE based on the first sidelink information, a set of receive beams and a set of receive beam repetition patterns associated with a set of sidelink SSBs. In some examples, the SSB component 935 may be configured as or otherwise support a means for receiving, from the second UE, the set of sidelink SSBs based on the set of receive beams and the set of receive beam repetition patterns.

In some examples, to support predicting, the prediction component 930 may be configured as or otherwise support a means for inputting the first sidelink information into a model configured to predict one or more reception characteristics associated with the set of sidelink SSBs. In some examples, to support predicting, the prediction component 930 may be configured as or otherwise support a means for obtaining, from the model, the set of receive beams and the set of receive beam repetition patterns.

In some examples, the beam notification component 940 may be configured as or otherwise support a means for transmitting, to the network entity, an indication of the set of receive beams and the set of receive beam repetition patterns.

In some examples, to support transmitting the indication of the set of receive beams and the set of receive beam repetition patterns, the beam notification component 940 may be configured as or otherwise support a means for transmitting an identifier associated with the set of receive beams and the set of receive beam repetition patterns, where respective pairings of different sets of receive beams and different sets of receive beam repetition patterns are associated with a respective identifier of a set of identifiers.

In some examples, the beam notification component 940 may be configured as or otherwise support a means for receiving, from the network entity, a confirmation of the set of receive beams and the set of receive beam repetition patterns, where receiving the set of sidelink SSBs includes receiving the set of sidelink SSBs in accordance with the set of receive beams and the set of receive beam repetition patterns.

In some examples, the beam notification component 940 may be configured as or otherwise support a means for receiving, from the network entity, an indication of an alternative set of receive beams and an alternative set of receive beam repetition patterns, where receiving the set of sidelink SSBs includes receiving the set of sidelink SSBs in accordance with the alternative set of receive beams and the alternative set of receive beam repetition patterns.

In some examples, the first sidelink information includes location information of the second UE, mobility information of the second UE, a first channel profile of a first link between the first UE and the network entity, a second channel profile of a second link between the second UE and the network entity, a third channel profile of a third link between the second UE and a third UE and location information of the third UE, or any combination thereof.

In some examples, the sidelink information component 925 may be configured as or otherwise support a means for receiving, from the network entity, second sidelink information associated with the first UE, the second UE, or both. In some examples, the prediction component 930 may be configured as or otherwise support a means for predicting, by the first UE based on the second sidelink information, a directional beam associated with a sidelink data message. In some examples, the sidelink data message component 945 may be configured as or otherwise support a means for communicating the sidelink data message with the second UE based on the directional beam.

In some examples, to support predicting the directional beam associated with the sidelink data message, the prediction component 930 may be configured as or otherwise support a means for inputting the second sidelink information into a model configured to predict one or more communication characteristics associated with the sidelink data message. In some examples, to support predicting the directional beam associated with the sidelink data message, the prediction component 930 may be configured as or otherwise support a means for obtaining, from the model, the directional beam.

In some examples, the second sidelink information includes a reference signal receive power associated with at least one of the set of sidelink SSBs, one or more receive beams and one or more receive beam repetition patterns used by the second UE, the first sidelink information, or any combination thereof.

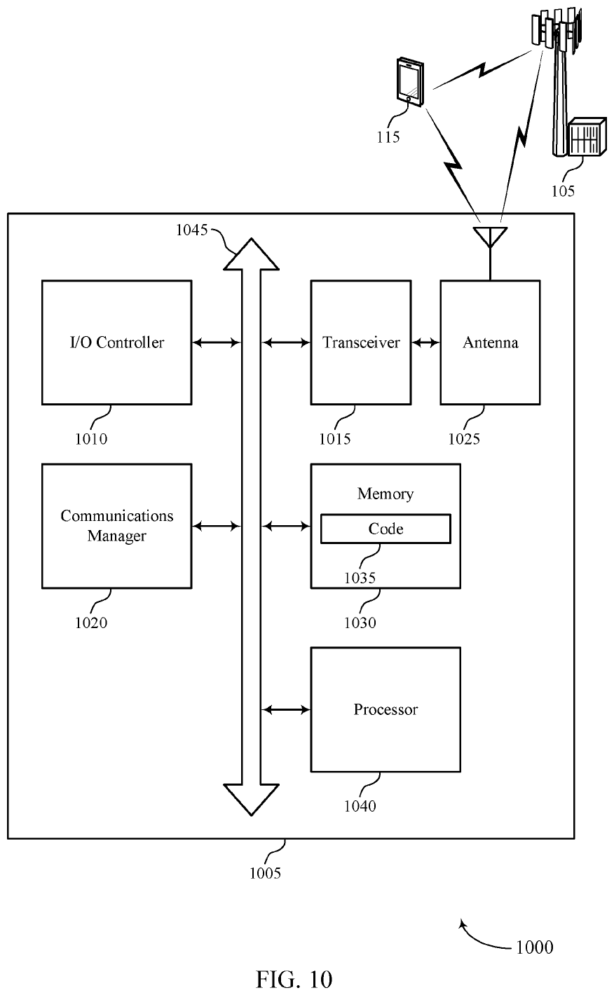

FIG. 10 shows a diagram of a system 1000 including a device 1005 that supports machine learning based predictive initial beam pairing for sidelink in accordance with one or more aspects of the present disclosure. The device 1005 may be an example of or include the components of a device 705, a device 805, or a UE 115 as described herein. The device 1005 may communicate (e.g., wirelessly) with one or more network entities 105, one or more UEs 115, or any combination thereof. The device 1005 may include components for bi-directional voice and data communications including components for transmitting and receiving communications, such as a communications manager 1020, an input/output (I/O) controller 1010, a transceiver 1015, an antenna 1025, a memory 1030, code 1035, and a processor 1040. These components may be in electronic communication or otherwise coupled (e.g., operatively, communicatively, functionally, electronically, electrically) via one or more buses (e.g., a bus 1045).

The I/O controller 1010 may manage input and output signals for the device 1005. The I/O controller 1010 may also manage peripherals not integrated into the device 1005. In some cases, the I/O controller 1010 may represent a physical connection or port to an external peripheral. In some cases, the I/O controller 1010 may utilize an operating system such as iOS®, ANDROID®, MS-DOS®, MS-WINDOWS®, OS/2®, UNIX®, LINUX®, or another known operating system. Additionally, or alternatively, the I/O controller 1010 may represent or interact with a modem, a keyboard, a mouse, a touchscreen, or a similar device. In some cases, the I/O controller 1010 may be implemented as part of a processor, such as the processor 1040. In some cases, a user may interact with the device 1005 via the I/O controller 1010 or via hardware components controlled by the I/O controller 1010.

In some cases, the device 1005 may include a single antenna 1025. However, in some other cases, the device 1005 may have more than one antenna 1025, which may be capable of concurrently transmitting or receiving multiple wireless transmissions. The transceiver 1015 may communicate bi-directionally, via the one or more antennas 1025, wired, or wireless links as described herein. For example, the transceiver 1015 may represent a wireless transceiver and may communicate bi-directionally with another wireless transceiver. The transceiver 1015 may also include a modem to modulate the packets, to provide the modulated packets to one or more antennas 1025 for transmission, and to demodulate packets received from the one or more antennas 1025. The transceiver 1015, or the transceiver 1015 and one or more antennas 1025, may be an example of a transmitter 715, a transmitter 815, a receiver 710, a receiver 810, or any combination thereof or component thereof, as described herein.

The memory 1030 may include random access memory (RAM) and read-only memory (ROM). The memory 1030 may store computer-readable, computer-executable code (e.g., code 1035) including instructions that, when executed by the processor 1040, cause the device 1005 to perform various functions described herein. The code 1035 may be stored in a non-transitory computer-readable medium such as system memory or another type of memory. In some cases, the code 1035 may not be directly executable by the processor 1040 but may cause a computer (e.g., when compiled and executed) to perform functions described herein. In some cases, the memory 1030 may contain, among other things, a basic I/O system (BIOS) which may control basic hardware or software operation such as the interaction with peripheral components or devices.

The processor 1040 may include an intelligent hardware device (e.g., a general-purpose processor, a DSP, a CPU, a microcontroller, an ASIC, an FPGA, a programmable logic device, a discrete gate or transistor logic component, a discrete hardware component, or any combination thereof). In some cases, the processor 1040 may be configured to operate a memory array using a memory controller. In some other cases, a memory controller may be integrated into the processor 1040. The processor 1040 may be configured to execute computer-readable instructions stored in a memory (e.g., the memory 1030) to cause the device 1005 to perform various functions (e.g., functions or tasks supporting machine learning based predictive initial beam pairing for sidelink). For example, the device 1005 or a component of the device 1005 may include a processor 1040 and memory 1030 coupled with or to the processor 1040, the processor 1040 and memory 1030 configured to perform various functions described herein.

The communications manager 1020 may support wireless communication at a first UE in accordance with examples as disclosed herein. For example, the communications manager 1020 may be configured as or otherwise support a means for receiving, from a network entity, first sidelink information associated with the first UE, a second UE, or both. The communications manager 1020 may be configured as or otherwise support a means for predicting, by the first UE based on the first sidelink information, a set of transmit beams and a set of transmit beam repetition patterns associated with a set of sidelink SSBs. The communications manager 1020 may be configured as or otherwise support a means for transmitting, to the second UE, the set of sidelink SSBs based on the set of transmit beams and the set of transmit beam repetition patterns.

Additionally, or alternatively, the communications manager 1020 may support wireless communications at a first UE in accordance with examples as disclosed herein. For example, the communications manager 1020 may be configured as or otherwise support a means for receiving, from a network entity, an indication of first sidelink information associated with the first UE, a second UE, or both. The communications manager 1020 may be configured as or otherwise support a means for predicting, by the first UE based on the first sidelink information, a set of receive beams and a set of receive beam repetition patterns associated with a set of sidelink SSBs. The communications manager 1020 may be configured as or otherwise support a means for receiving, from the second UE, the set of sidelink SSBs based on the set of receive beams and the set of receive beam repetition patterns.

By including or configuring the communications manager 1020 in accordance with examples as described herein, the device 1005 may support techniques for improved communication reliability, reduced latency, improved user experience related to reduced processing, reduced power consumption, more efficient utilization of communication resources, improved coordination between devices, longer battery life, and improved utilization of processing capability.

In some examples, the communications manager 1020 may be configured to perform various operations (e.g., receiving, monitoring, transmitting) using or otherwise in cooperation with the transceiver 1015, the one or more antennas 1025, or any combination thereof. Although the communications manager 1020 is illustrated as a separate component, in some examples, one or more functions described herein with reference to the communications manager 1020 may be supported by or performed by the processor 1040, the memory 1030, the code 1035, or any combination thereof. For example, the code 1035 may include instructions executable by the processor 1040 to cause the device 1005 to perform various aspects of machine learning based predictive initial beam pairing for sidelink as described herein, or the processor 1040 and the memory 1030 may be otherwise configured to perform or support such operations.

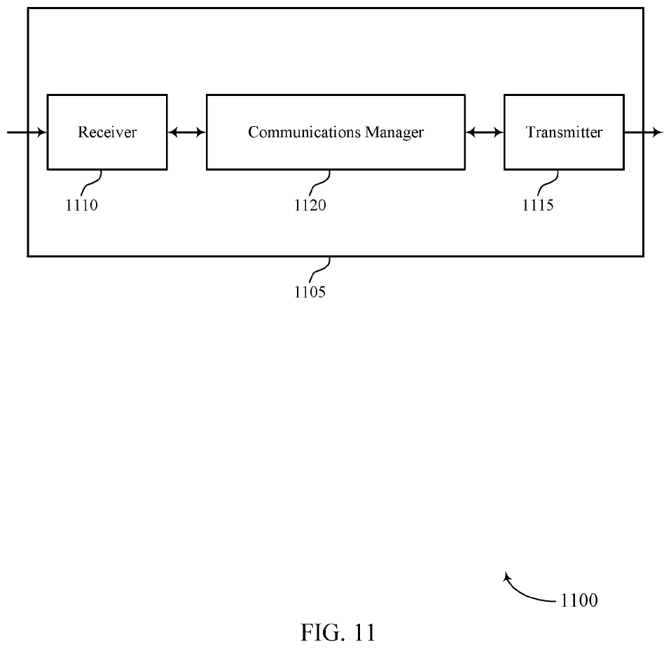

FIG. 11 shows a block diagram 1100 of a device 1105 that supports machine learning based predictive initial beam pairing for sidelink in accordance with one or more aspects of the present disclosure. The device 1105 may be an example of aspects of a network entity 105 as described herein. The device 1105 may include a receiver 1110, a transmitter 1115, and a communications manager 1120. The device 1105 may also include a processor (not shown). Each of these components may be in communication with one another (e.g., via one or more buses).

The receiver 1110 may provide a means for obtaining (e.g., receiving, determining, identifying) information such as user data, control information, or any combination thereof (e.g., I/Q samples, symbols, packets, protocol data units, service data units) associated with various channels (e.g., control channels, data channels, information channels, channels associated with a protocol stack). Information may be passed on to other components of the device 1105. In some examples, the receiver 1110 may support obtaining information by receiving signals via one or more antennas. Additionally, or alternatively, the receiver 1110 may support obtaining information by receiving signals via one or more wired (e.g., electrical, fiber optic) interfaces, wireless interfaces, or any combination thereof.

The transmitter 1115 may provide a means for outputting (e.g., transmitting, providing, conveying, sending) information generated by other components of the device 1105. For example, the transmitter 1115 may output information such as user data, control information, or any combination thereof (e.g., I/Q samples, symbols, packets, protocol data units, service data units) associated with various channels (e.g., control channels, data channels, information channels, channels associated with a protocol stack). In some examples, the transmitter 1115 may support outputting information by transmitting signals via one or more antennas. Additionally, or alternatively, the transmitter 1115 may support outputting information by transmitting signals via one or more wired (e.g., electrical, fiber optic) interfaces, wireless interfaces, or any combination thereof. In some examples, the transmitter 1115 and the receiver 1110 may be co-located in a transceiver, which may include or be coupled with a modem.

The communications manager 1120, the receiver 1110, the transmitter 1115, or various combinations thereof or various components thereof may be examples of means for performing various aspects of machine learning based predictive initial beam pairing for sidelink as described herein. For example, the communications manager 1120, the receiver 1110, the transmitter 1115, or various combinations or components thereof may support a method for performing one or more of the functions described herein.

In some examples, the communications manager 1120, the receiver 1110, the transmitter 1115, or various combinations or components thereof may be implemented in hardware (e.g., in communications management circuitry). The hardware may include a processor, a DSP, a CPU, an ASIC, an FPGA or other programmable logic device, a microcontroller, discrete gate or transistor logic, discrete hardware components, or any combination thereof configured as or otherwise supporting a means for performing the functions described in the present disclosure. In some examples, a processor and memory coupled with the processor may be configured to perform one or more of the functions described herein (e.g., by executing, by the processor, instructions stored in the memory).

Additionally, or alternatively, in some examples, the communications manager 1120, the receiver 1110, the transmitter 1115, or various combinations or components thereof may be implemented in code (e.g., as communications management software or firmware) executed by a processor. If implemented in code executed by a processor, the functions of the communications manager 1120, the receiver 1110, the transmitter 1115, or various combinations or components thereof may be performed by a general-purpose processor, a DSP, a CPU, an ASIC, an FPGA, a microcontroller, or any combination of these or other programmable logic devices (e.g., configured as or otherwise supporting a means for performing the functions described in the present disclosure).

In some examples, the communications manager 1120 may be configured to perform various operations (e.g., receiving, obtaining, monitoring, outputting, transmitting) using or otherwise in cooperation with the receiver 1110, the transmitter 1115, or both. For example, the communications manager 1120 may receive information from the receiver 1110, send information to the transmitter 1115, or be integrated in combination with the receiver 1110, the transmitter 1115, or both to obtain information, output information, or perform various other operations as described herein.

The communications manager 1120 may support wireless communications at a network entity in accordance with examples as disclosed herein. For example, the communications manager 1120 may be configured as or otherwise support a means for obtaining first sidelink information associated with a first UE, a second UE, or both. The communications manager 1120 may be configured as or otherwise support a means for transmitting, to the first UE, the first sidelink information associated with the first UE, the second UE, or both. The communications manager 1120 may be configured as or otherwise support a means for receiving, from the first UE, an indication of a set of directional beams and a set of directional beam repetition patterns based on the first sidelink information, where the set of directional beams and the set of directional beam repetition patterns are predictions for a set of sidelink SSBs to be transmitted between the first UE and the second UE.

By including or configuring the communications manager 1120 in accordance with examples as described herein, the device 1105 (e.g., a processor controlling or otherwise coupled with the receiver 1110, the transmitter 1115, the communications manager 1120, or any combination thereof) may support techniques for reduced processing, reduced power consumption, and more efficient utilization of communication resources.

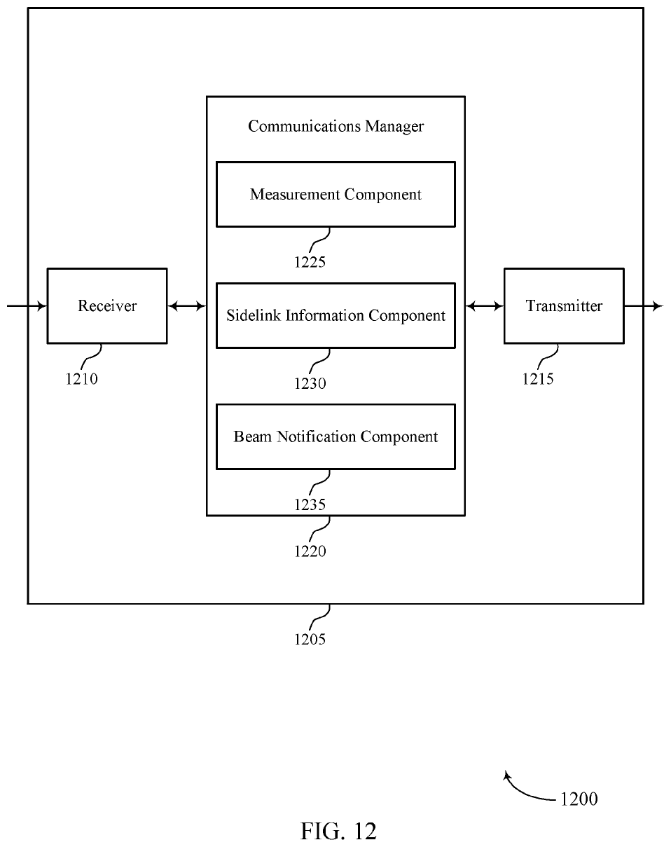

FIG. 12 shows a block diagram 1200 of a device 1205 that supports machine learning based predictive initial beam pairing for sidelink in accordance with one or more aspects of the present disclosure. The device 1205 may be an example of aspects of a device 1105 or a network entity 105 as described herein. The device 1205 may include a receiver 1210, a transmitter 1215, and a communications manager 1220. The device 1205 may also include a processor. Each of these components may be in communication with one another (e.g., via one or more buses).

The receiver 1210 may provide a means for obtaining (e.g., receiving, determining, identifying) information such as user data, control information, or any combination thereof (e.g., I/Q samples, symbols, packets, protocol data units, service data units) associated with various channels (e.g., control channels, data channels, information channels, channels associated with a protocol stack). Information may be passed on to other components of the device 1205. In some examples, the receiver 1210 may support obtaining information by receiving signals via one or more antennas. Additionally, or alternatively, the receiver 1210 may support obtaining information by receiving signals via one or more wired (e.g., electrical, fiber optic) interfaces, wireless interfaces, or any combination thereof.

The transmitter 1215 may provide a means for outputting (e.g., transmitting, providing, conveying, sending) information generated by other components of the device 1205. For example, the transmitter 1215 may output information such as user data, control information, or any combination thereof (e.g., I/Q samples, symbols, packets, protocol data units, service data units) associated with various channels (e.g., control channels, data channels, information channels, channels associated with a protocol stack). In some examples, the transmitter 1215 may support outputting information by transmitting signals via one or more antennas. Additionally, or alternatively, the transmitter 1215 may support outputting information by transmitting signals via one or more wired (e.g., electrical, fiber optic) interfaces, wireless interfaces, or any combination thereof. In some examples, the transmitter 1215 and the receiver 1210 may be co-located in a transceiver, which may include or be coupled with a modem.

The device 1205, or various components thereof, may be an example of means for performing various aspects of machine learning based predictive initial beam pairing for sidelink as described herein. For example, the communications manager 1220 may include a measurement component 1225, a sidelink information component 1230, a beam notification component 1235, or any combination thereof. The communications manager 1220 may be an example of aspects of a communications manager 1120 as described herein. In some examples, the communications manager 1220, or various components thereof, may be configured to perform various operations (e.g., receiving, obtaining, monitoring, outputting, transmitting) using or otherwise in cooperation with the receiver 1210, the transmitter 1215, or both. For example, the communications manager 1220 may receive information from the receiver 1210, send information to the transmitter 1215, or be integrated in combination with the receiver 1210, the transmitter 1215, or both to obtain information, output information, or perform various other operations as described herein.

The communications manager 1220 may support wireless communications at a network entity in accordance with examples as disclosed herein. The measurement component 1225 may be configured as or otherwise support a means for obtaining first sidelink information associated with a first UE, a second UE, or both. The sidelink information component 1230 may be configured as or otherwise support a means for transmitting, to the first UE, the first sidelink information associated with the first UE, the second UE, or both. The beam notification component 1235 may be configured as or otherwise support a means for receiving, from the first UE, an indication of a set of directional beams and a set of directional beam repetition patterns based on the first sidelink information, where the set of directional beams and the set of directional beam repetition patterns are predictions for a set of sidelink SSBs to be transmitted between the first UE and the second UE.

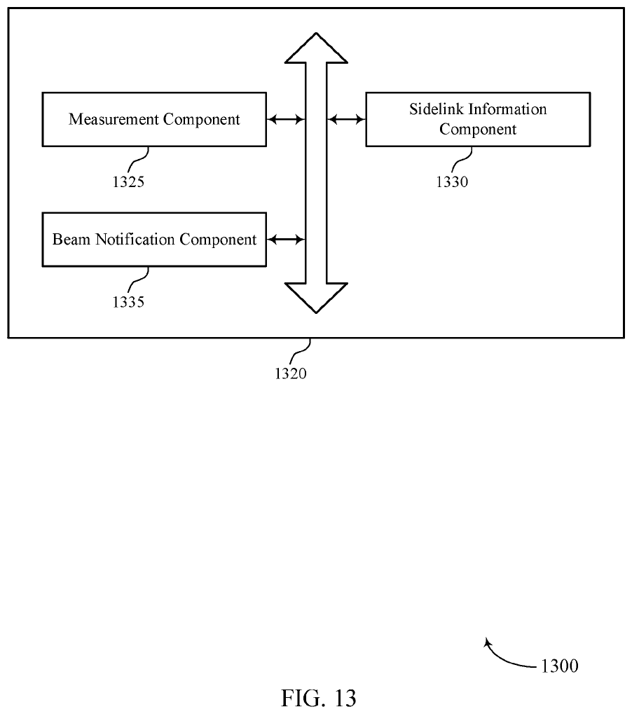

FIG. 13 shows a block diagram 1300 of a communications manager 1320 that supports machine learning based predictive initial beam pairing for sidelink in accordance with one or more aspects of the present disclosure. The communications manager 1320 may be an example of aspects of a communications manager 1120, a communications manager 1220, or both, as described herein. The communications manager 1320, or various components thereof, may be an example of means for performing various aspects of machine learning based predictive initial beam pairing for sidelink as described herein. For example, the communications manager 1320 may include a measurement component 1325, a sidelink information component 1330, a beam notification component 1335, or any combination thereof. Each of these components may communicate, directly or indirectly, with one another (e.g., via one or more buses) which may include communications within a protocol layer of a protocol stack, communications associated with a logical channel of a protocol stack (e.g., between protocol layers of a protocol stack, within a device, component, or virtualized component associated with a network entity 105, between devices, components, or virtualized components associated with a network entity 105), or any combination thereof.

The communications manager 1320 may support wireless communications at a network entity in accordance with examples as disclosed herein. The measurement component 1325 may be configured as or otherwise support a means for obtaining first sidelink information associated with a first UE, a second UE, or both. The sidelink information component 1330 may be configured as or otherwise support a means for transmitting, to the first UE, the first sidelink information associated with the first UE, the second UE, or both. The beam notification component 1335 may be configured as or otherwise support a means for receiving, from the first UE, an indication of a set of directional beams and a set of directional beam repetition patterns based on the first sidelink information, where the set of directional beams and the set of directional beam repetition patterns are predictions for a set of sidelink SSBs to be transmitted between the first UE and the second UE.

In some examples, to support receiving the indication of the set of directional beams and the set of directional beam repetition patterns, the beam notification component 1335 may be configured as or otherwise support a means for receiving an identifier associated with the set of directional beams and the set of directional beam repetition patterns, where respective pairings of different sets of directional beams and different sets of directional beam repetition patterns are associated with a respective identifier of a set of identifiers.

In some examples, the beam notification component 1335 may be configured as or otherwise support a means for transmitting, to the first UE, a request for the indication of the set of directional beams and the set of directional beam repetition patterns, where receiving the indication of the set of directional beams and the set of directional beam repetition patterns is based on transmitting the request.

In some examples, the beam notification component 1335 may be configured as or otherwise support a means for transmitting, to the first UE, a confirmation of the set of directional beams and the set of directional beam repetition patterns. In some examples, the beam notification component 1335 may be configured as or otherwise support a means for transmitting, to the first UE, an indication of an alternative set of directional beams and an alternative set of directional beam repetition patterns.

In some examples, the first sidelink information includes location information of the second UE, mobility information of the second UE, a first channel profile of a first link between the first UE and the network entity, a second channel profile of a second link between the second UE and the network entity, a third channel profile of a third link between the second UE and a third UE and location information of the third UE, or any combination thereof.

In some examples, the set of directional beams and the set of directional beam repetition patterns are associated with a set of sidelink SSB occasions. In some examples, each sidelink SSB occasion of the set of sidelink SSB occasions includes a sub-occasion group of one or more sub-occasions. In some examples, each sub-occasion of a given sub-occasion group is associated with a same directional beam. In some examples, different sub-occasion groups are associated with different directional beams.

In some examples, the measurement component 1325 may be configured as or otherwise support a means for obtaining second sidelink information from the first UE, the second UE, or both. In some examples, the sidelink information component 1330 may be configured as or otherwise support a means for transmitting, to the first UE, the second sidelink information associated with the first UE, the second UE, or both. In some examples, the beam notification component 1335 may be configured as or otherwise support a means for receiving, from the first UE, an indication of a directional beam, where the directional beam is a prediction for a sidelink data message to be transmitted between the first UE and the second UE.

In some examples, the second sidelink information includes a reference signal receive power associated with at least one of the set of sidelink SSBs, one or more receive beams and one or more receive beam repetition patterns used by the second UE, the first sidelink information, or any combination thereof.

In some examples, the beam notification component 1335 may be configured as or otherwise support a means for transmitting, to the second UE, an indication of the set of directional beams and the set of directional beam repetition patterns in accordance with the set of directional beams and the set of directional beam repetition patterns being the predictions for the set of sidelink SSBs to be transmitted between the first UE and the second UE.

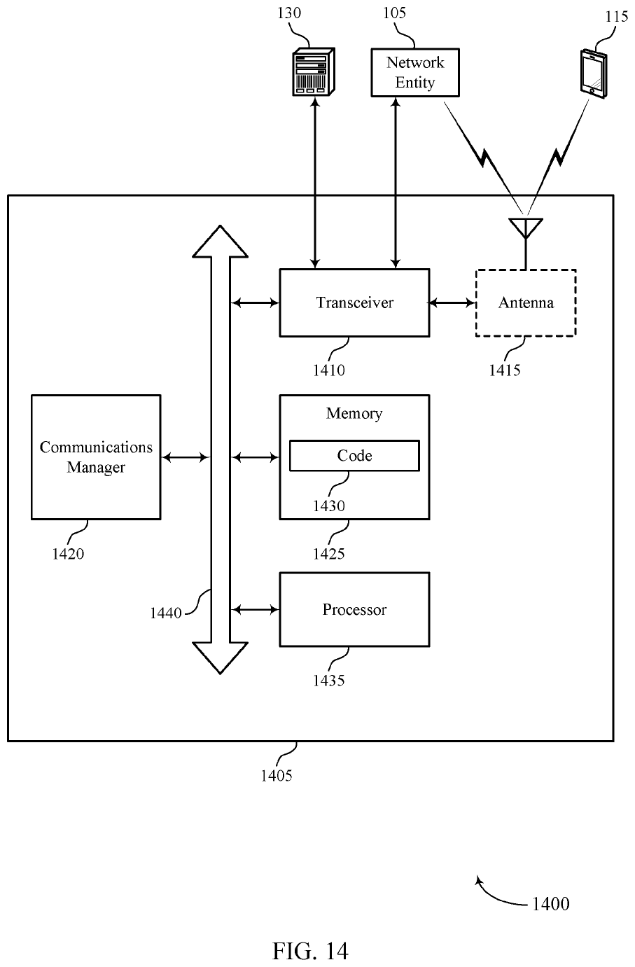

FIG. 14 shows a diagram of a system 1400 including a device 1405 that supports machine learning based predictive initial beam pairing for sidelink in accordance with one or more aspects of the present disclosure. The device 1405 may be an example of or include the components of a device 1105, a device 1205, or a network entity 105 as described herein. The device 1405 may communicate with one or more network entities 105, one or more UEs 115, or any combination thereof, which may include communications over one or more wired interfaces, over one or more wireless interfaces, or any combination thereof. The device 1405 may include components that support outputting and obtaining communications, such as a communications manager 1420, a transceiver 1410, an antenna 1415, a memory 1425, code 1430, and a processor 1435. These components may be in electronic communication or otherwise coupled (e.g., operatively, communicatively, functionally, electronically, electrically) via one or more buses (e.g., a bus 1440).

The transceiver 1410 may support bi-directional communications via wired links, wireless links, or both as described herein. In some examples, the transceiver 1410 may include a wired transceiver and may communicate bi-directionally with another wired transceiver. Additionally, or alternatively, in some examples, the transceiver 1410 may include a wireless transceiver and may communicate bi-directionally with another wireless transceiver. In some examples, the device 1405 may include one or more antennas 1415, which may be capable of transmitting or receiving wireless transmissions (e.g., concurrently). The transceiver 1410 may also include a modem to modulate signals, to provide the modulated signals for transmission (e.g., by one or more antennas 1415, by a wired transmitter), to receive modulated signals (e.g., from one or more antennas 1415, from a wired receiver), and to demodulate signals. The transceiver 1410, or the transceiver 1410 and one or more antennas 1415 or wired interfaces, where applicable, may be an example of a transmitter 1115, a transmitter 1215, a receiver 1110, a receiver 1210, or any combination thereof or component thereof, as described herein. In some examples, the transceiver may be operable to support communications via one or more communications links (e.g., a communication link 125, a backhaul communication link 120, a midhaul communication link 162, a fronthaul communication link 168).

The memory 1425 may include RAM and ROM. The memory 1425 may store computer-readable, computer-executable code (e.g., code 1430) including instructions that, when executed by the processor 1435, cause the device 1405 to perform various functions described herein. The code 1430 may be stored in a non-transitory computer-readable medium such as system memory or another type of memory. In some cases, the code 1430 may not be directly executable by the processor 1435 but may cause a computer (e.g., when compiled and executed) to perform functions described herein. In some cases, the memory 1425 may contain, among other things, a BIOS which may control basic hardware or software operation such as the interaction with peripheral components or devices.

The processor 1435 may include an intelligent hardware device (e.g., a general-purpose processor, a DSP, an ASIC, a CPU, an FPGA, a microcontroller, a programmable logic device, discrete gate or transistor logic, a discrete hardware component, or any combination thereof). In some cases, the processor 1435 may be configured to operate a memory array using a memory controller. In some other cases, a memory controller may be integrated into the processor 1435. The processor 1435 may be configured to execute computer-readable instructions stored in a memory (e.g., the memory 1425) to cause the device 1405 to perform various functions (e.g., functions or tasks supporting machine learning based predictive initial beam pairing for sidelink). For example, the device 1405 or a component of the device 1405 may include a processor 1435 and memory 1425 coupled with the processor 1435, the processor 1435 and memory 1425 configured to perform various functions described herein. The processor 1435 may be an example of a cloud-computing platform (e.g., one or more physical nodes and supporting software such as operating systems, virtual machines, or container instances) that may host the functions (e.g., by executing code 1430) to perform the functions of the device 1405.

In some examples, a bus 1440 may support communications of (e.g., within) a protocol layer of a protocol stack. In some examples, a bus 1440 may support communications associated with a logical channel of a protocol stack (e.g., between protocol layers of a protocol stack), which may include communications performed within a component of the device 1405, or between different components of the device 1405 that may be co-located or located in different locations (e.g., where the device 1405 may refer to a system in which one or more of the communications manager 1420, the transceiver 1410, the memory 1425, the code 1430, and the processor 1435 may be located in one of the different components or divided between different components).

In some examples, the communications manager 1420 may manage aspects of communications with a core network 130 (e.g., via one or more wired or wireless backhaul links). For example, the communications manager 1420 may manage the transfer of data communications for client devices, such as one or more UEs 115. In some examples, the communications manager 1420 may manage communications with other network entities 105, and may include a controller or scheduler for controlling communications with UEs 115 in cooperation with other network entities 105. In some examples, the communications manager 1420 may support an X2 interface within an LTE/LTE-A wireless communications network technology to provide communication between network entities 105.

The communications manager 1420 may support wireless communications at a network entity in accordance with examples as disclosed herein. For example, the communications manager 1420 may be configured as or otherwise support a means for obtaining first sidelink information associated with a first UE, a second UE, or both. The communications manager 1420 may be configured as or otherwise support a means for transmitting, to the first UE, the first sidelink information associated with the first UE, the second UE, or both. The communications manager 1420 may be configured as or otherwise support a means for receiving, from the first UE, an indication of a set of directional beams and a set of directional beam repetition patterns based on the first sidelink information, where the set of directional beams and the set of directional beam repetition patterns are predictions for a set of sidelink SSBs to be transmitted between the first UE and the second UE.

By including or configuring the communications manager 1420 in accordance with examples as described herein, the device 1405 may support techniques for improved communication reliability, reduced latency, improved user experience related to reduced processing, reduced power consumption, more efficient utilization of communication resources, improved coordination between devices, longer battery life, and improved utilization of processing capability.

In some examples, the communications manager 1420 may be configured to perform various operations (e.g., receiving, obtaining, monitoring, outputting, transmitting) using or otherwise in cooperation with the transceiver 1410, the one or more antennas 1415 (e.g., where applicable), or any combination thereof. Although the communications manager 1420 is illustrated as a separate component, in some examples, one or more functions described herein with reference to the communications manager 1420 may be supported by or performed by the processor 1435, the memory 1425, the code 1430, the transceiver 1410, or any combination thereof. For example, the code 1430 may include instructions executable by the processor 1435 to cause the device 1405 to perform various aspects of machine learning based predictive initial beam pairing for sidelink as described herein, or the processor 1435 and the memory 1425 may be otherwise configured to perform or support such operations.

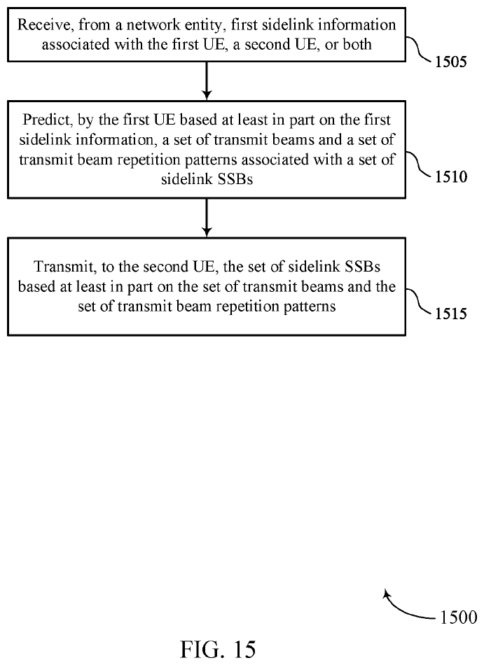

FIG. 15 shows a flowchart illustrating a method 1500 that supports machine learning based predictive initial beam pairing for sidelink in accordance with one or more aspects of the present disclosure. The operations of the method 1500 may be implemented by a UE or its components as described herein. For example, the operations of the method 1500 may be performed by a UE 115 as described herein with reference to FIGS. 1 through 10. In some examples, a UE may execute a set of instructions to control the functional elements of the UE to perform the described functions. Additionally, or alternatively, the UE may perform aspects of the described functions using special-purpose hardware.

At 1505, the method may include receiving, from a network entity, first sidelink information associated with the first UE, a second UE, or both. The operations of 1505 may be performed in accordance with examples as disclosed herein. In some examples, aspects of the operations of 1505 may be performed by a sidelink information component 925 as described herein with reference to FIG. 9.

At 1510, the method may include predicting, by the first UE based at least in part on the first sidelink information, a set of transmit beams and a set of transmit beam repetition patterns associated with a set of sidelink SSBs. The operations of 1510 may be performed in accordance with examples as disclosed herein. In some examples, aspects of the operations of 1510 may be performed by a prediction component 930 as described herein with reference to FIG. 9.

At 1515, the method may include transmitting, to the second UE, the set of sidelink SSBs based at least in part on the set of transmit beams and the set of transmit beam repetition patterns. The operations of 1515 may be performed in accordance with examples as disclosed herein. In some examples, aspects of the operations of 1515 may be performed by an SSB component 935 as described herein with reference to FIG. 9.

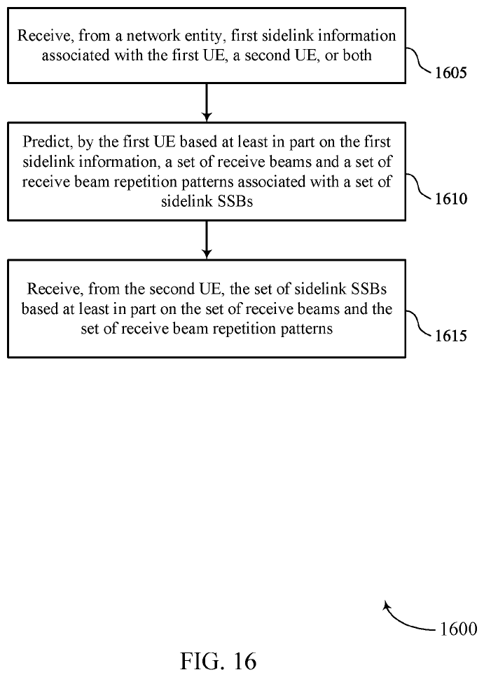

FIG. 16 shows a flowchart illustrating a method 1600 that supports machine learning based predictive initial beam pairing for sidelink in accordance with one or more aspects of the present disclosure. The operations of the method 1600 may be implemented by a UE or its components as described herein. For example, the operations of the method 1600 may be performed by a UE 115 as described herein with reference to FIGS. 1 through 10. In some examples, a UE may execute a set of instructions to control the functional elements of the UE to perform the described functions. Additionally, or alternatively, the UE may perform aspects of the described functions using special-purpose hardware.

At 1605, the method may include receiving, from a network entity, an indication of first sidelink information associated with the first UE, a second UE, or both. The operations of 1605 may be performed in accordance with examples as disclosed herein. In some examples, aspects of the operations of 1605 may be performed by a sidelink information component 925 as described herein with reference to FIG. 9.

At 1610, the method may include predicting, by the first UE based at least in part on the first sidelink information, a set of receive beams and a set of receive beam repetition patterns associated with a set of sidelink SSBs. The operations of 1610 may be performed in accordance with examples as disclosed herein. In some examples, aspects of the operations of 1610 may be performed by a prediction component 930 as described herein with reference to FIG. 9.

At 1615, the method may include receiving, from the second UE, the set of sidelink SSBs based at least in part on the set of receive beams and the set of receive beam repetition patterns. The operations of 1615 may be performed in accordance with examples as disclosed herein. In some examples, aspects of the operations of 1615 may be performed by an SSB component 935 as described herein with reference to FIG. 9.

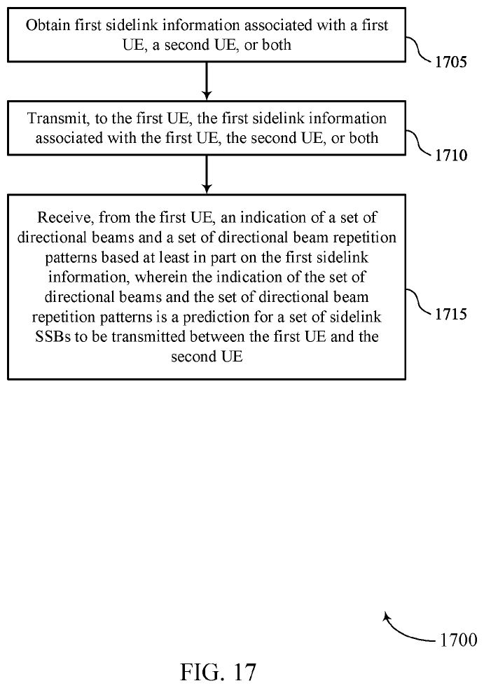

FIG. 17 shows a flowchart illustrating a method 1700 that supports machine learning based predictive initial beam pairing for sidelink in accordance with one or more aspects of the present disclosure. The operations of the method 1700 may be implemented by a network entity or its components as described herein. For example, the operations of the method 1700 may be performed by a network entity as described herein with reference to FIGS. 1 through 6 and 11 through 14. In some examples, a network entity may execute a set of instructions to control the functional elements of the network entity to perform the described functions. Additionally, or alternatively, the network entity may perform aspects of the described functions using special-purpose hardware.

At 1705, the method may include obtaining first sidelink information associated with a first UE, a second UE, or both. The operations of 1705 may be performed in accordance with examples as disclosed herein. In some examples, aspects of the operations of 1705 may be performed by a measurement component 1325 as described herein with reference to FIG. 13.

At 1710, the method may include transmitting, to the first UE, the first sidelink information associated with the first UE, the second UE, or both. The operations of 1710 may be performed in accordance with examples as disclosed herein. In some examples, aspects of the operations of 1710 may be performed by a sidelink information component 1330 as described herein with reference to FIG. 13.

At 1715, the method may include receiving, from the first UE, an indication of a set of directional beams and a set of directional beam repetition patterns based at least in part on the first sidelink information, where the set of directional beams and the set of directional beam repetition patterns are predictions for a set of sidelink SSBs to be transmitted between the first UE and the second UE. The operations of 1715 may be performed in accordance with examples as disclosed herein. In some examples, aspects of the operations of 1715 may be performed by a beam notification component 1335 as described herein with reference to FIG. 13.

The following provides an overview of aspects of the present disclosure:

Aspect 1: A method for wireless communication at a first UE, comprising: receiving, from a network entity, first sidelink information associated with the first UE, a second UE, or both; predicting, by the first UE based at least in part on the first sidelink information, a set of transmit beams and a set of transmit beam repetition patterns associated with a set of sidelink SSBs; and transmitting, to the second UE, the set of sidelink SSBs based at least in part on the set of transmit beams and the set of transmit beam repetition patterns.

Aspect 2: The method of aspect 1, wherein predicting the set of transmit beams and the set of transmit beam repetition patterns associated with a set of sidelink SSBs comprises: inputting the first sidelink information into a model configured to predict one or more transmission characteristics associated with the set of sidelink SSBs; and obtaining, from the model, the set of transmit beams and the set of transmit beam repetition patterns.

Aspect 3: The method of any of aspects 1 through 2, further comprising: transmitting, to the network entity, an indication of the set of transmit beams and the set of transmit beam repetition patterns.

Aspect 4: The method of aspect 3, wherein transmitting the indication of the set of transmit beams and the set of transmit beam repetition patterns comprises: transmitting an identifier associated with the set of transmit beams and the set of transmit beam repetition patterns, wherein respective pairings of different sets of transmit beams and different sets of transmit beam repetition patterns are associated with a respective identifier of a set of identifiers.

Aspect 5: The method of any of aspects 3 through 4, further comprising: receiving, from the network entity, a request for the indication of the set of transmit beams and the set of transmit beam repetition patterns, wherein transmitting the indication of the set of transmit beams and the set of transmit beam repetition patterns is based at least in part on receiving the request.

Aspect 6: The method of aspect 5, further comprising: transmitting, to the network entity, a request to report the indication of the set of transmit beams and the set of transmit beam repetition patterns, wherein receiving the request for the indication of the set of transmit beams and the set of transmit beam repetition patterns is based at least in part on transmitting the request to report the indication of the set of transmit beams and the set of transmit beam repetition patterns.

Aspect 7: The method of any of aspects 3 through 6, further comprising: receiving, from the network entity, a confirmation of the set of transmit beams and the set of transmit beam repetition patterns, wherein transmitting the set of sidelink SSBs comprises transmitting the set of sidelink SSBs in accordance with the set of transmit beams and the set of transmit beam repetition patterns.

Aspect 8: The method of any of aspects 3 through 6, further comprising: receiving, from the network entity, an indication of an alternative set of transmit beams and an alternative set of transmit beam repetition patterns, wherein transmitting the set of sidelink SSBs comprises transmitting the set of sidelink SSBs in accordance with the alternative set of transmit beams and the alternative set of transmit beam repetition patterns.

Aspect 9: The method of any of aspects 1 through 8, further comprising: transmitting, to the network entity, a request for the first sidelink information, wherein receiving the first sidelink information is based at least in part on transmitting the request.

Aspect 10: The method of any of aspects 1 through 9, wherein the first sidelink information comprises location information of the second UE, mobility information of the second UE, a first channel profile of a first link between the first UE and the network entity, a second channel profile of a second link between the second UE and the network entity, a third channel profile of a third link between the second UE and a third UE and location information of the third UE, or any combination thereof.

Aspect 11: The method of any of aspects 1 through 10, wherein the set of transmit beams and the set of transmit beam repetition patterns are associated with a set of sidelink SSB occasions, each sidelink SSB occasion of the set of sidelink SSB occasions includes a sub-occasion group of one or more sub-occasions, each sub-occasion of a given sub-occasion group is associated with a same transmit beam, and different sub-occasion groups are associated with different transmit beams.

Aspect 12: The method of any of aspects 1 through 11, further comprising: receiving, from the network entity, second sidelink information associated with the first UE, the second UE, or both; predicting, by the first UE based at least in part on the second sidelink information, a directional beam associated with a sidelink data message; and communicating the sidelink data message with the second UE based at least in part on the directional beam.

Aspect 13: The method of aspect 12, wherein predicting the directional beam associated with the sidelink data message comprises: inputting the second sidelink information into a model configured to predict one or more communication characteristics associated with the sidelink data message; and obtaining, from the model, the directional beam.

Aspect 14: The method of any of aspects 12 through 13, further comprising: transmitting, to the network entity, an indication of the directional beam.

Aspect 15: The method of aspect 14, further comprising: receiving, from the network entity, a request for the indication of the directional beam, wherein communicating the indication of the directional beam is based at least in part on receiving the request.

Aspect 16: The method of aspect 15, further comprising: transmitting, to the network entity, a request to report the indication of the directional beam, wherein receiving the request for the indication of the directional beam is based at least in part on transmitting the request to report the indication of the directional beam.

Aspect 17: The method of any of aspects 14 through 16, further comprising: receiving, from the network entity, a confirmation of the directional beam, wherein communicating the sidelink data message comprises transmitting or receiving the sidelink data message using the directional beam.

Aspect 18: The method of any of aspects 14 through 16, further comprising: receiving, from the network entity, an indication of an alternative directional beam, wherein communicating the sidelink data message comprises transmitting or receiving the sidelink data message using the alternative directional beam.

Aspect 19: The method of any of aspects 12 through 18, wherein the second sidelink information comprises a reference signal receive power associated with at least one of the set of sidelink SSBs, one or more receive beams and one or more receive beam repetition patterns used by the second UE, the first sidelink information, or any combination thereof.

Aspect 20: A method for wireless communications at a first UE, comprising: receiving, from a network entity, an indication of first sidelink information associated with the first UE, a second UE, or both; predicting, by the first UE based at least in part on the first sidelink information, a set of receive beams and a set of receive beam repetition patterns associated with a set of sidelink SSBs; and receiving, from the second UE, the set of sidelink SSBs based at least in part on the set of receive beams and the set of receive beam repetition patterns.

Aspect 21: The method of aspect 20, wherein the predicting comprises: inputting the first sidelink information into a model configured to predict one or more reception characteristics associated with the set of sidelink SSBs; and obtaining, from the model, the set of receive beams and the set of receive beam repetition patterns.

Aspect 22: The method of any of aspects 20 through 21, further comprising: transmitting, to the network entity, an indication of the set of receive beams and the set of receive beam repetition patterns.

Aspect 23: The method of aspect 22, wherein transmitting the indication of the set of receive beams and the set of receive beam repetition patterns comprises: transmitting an identifier associated with the set of receive beams and the set of receive beam repetition patterns, wherein respective pairings of different sets of receive beams and different sets of receive beam repetition patterns are associated with a respective identifier of a set of identifiers.

Aspect 24: The method of any of aspects 22 through 23, further comprising: receiving, from the network entity, a confirmation of the set of receive beams and the set of receive beam repetition patterns, wherein receiving the set of sidelink SSBs comprises receiving the set of sidelink SSBs in accordance with the set of receive beams and the set of receive beam repetition patterns.

Aspect 25: The method of any of aspects 22 through 23, further comprising: receiving, from the network entity, an indication of an alternative set of receive beams and an alternative set of receive beam repetition patterns, wherein receiving the set of sidelink SSBs comprises receiving the set of sidelink SSBs in accordance with the alternative set of receive beams and the alternative set of receive beam repetition patterns.

Aspect 26: The method of any of aspects 20 through 25, wherein the first sidelink information comprises location information of the second UE, mobility information of the second UE, a first channel profile of a first link between the first UE and the network entity, a second channel profile of a second link between the second UE and the network entity, a third channel profile of a third link between the second UE and a third UE and location information of the third UE, or any combination thereof.

Aspect 27: The method of any of aspects 20 through 26, further comprising: receiving, from the network entity, second sidelink information associated with the first UE, the second UE, or both; predicting, by the first UE based at least in part on the second sidelink information, a directional beam associated with a sidelink data message; and communicating the sidelink data message with the second UE based at least in part on the directional beam.

Aspect 28: The method of aspect 27, wherein predicting the directional beam associated with the sidelink data message comprises: inputting the second sidelink information into a model configured to predict one or more communication characteristics associated with the sidelink data message; and obtaining, from the model, the directional beam.

Aspect 29: The method of any of aspects 27 through 28, wherein the second sidelink information comprises a reference signal receive power associated with at least one of the set of sidelink SSBs, one or more receive beams and one or more receive beam repetition patterns used by the second UE, the first sidelink information, or any combination thereof.

Aspect 30: A method for wireless communications at a network entity, comprising: obtaining first sidelink information associated with a first UE, a second UE, or both; transmitting, to the first UE, the first sidelink information associated with the first UE, the second UE, or both; and receiving, from the first UE, an indication of a set of directional beams and a set of directional beam repetition patterns based at least in part on the first sidelink information, wherein the set of directional beams and the set of directional beam repetition patterns are predictions for a set of sidelink SSBs to be transmitted between the first UE and the second UE.

Aspect 31: The method of aspect 30, wherein receiving the indication of the set of directional beams and the set of directional beam repetition patterns comprises: receiving an identifier associated with the set of directional beams and the set of directional beam repetition patterns, wherein respective pairings of different sets of directional beams and different sets of directional beam repetition patterns are associated with a respective identifier of a set of identifiers.

Aspect 32: The method of any of aspects 30 through 31, further comprising: transmitting, to the first UE, a request for the indication of the set of directional beams and the set of directional beam repetition patterns, wherein receiving the indication of the set of directional beams and the set of directional beam repetition patterns is based at least in part on transmitting the request.

Aspect 33: The method of any of aspects 30 through 32, further comprising: transmitting, to the first UE, a confirmation of the set of directional beams and the set of directional beam repetition patterns; or transmitting, to the first UE, an indication of an alternative set of directional beams and an alternative set of directional beam repetition patterns.

Aspect 34: The method of any of aspects 30 through 32, wherein the first sidelink information comprises location information of the second UE, mobility information of the second UE, a first channel profile of a first link between the first UE and the network entity, a second channel profile of a second link between the second UE and the network entity, a third channel profile of a third link between the second UE and a third UE and location information of the third UE, or any combination thereof.

Aspect 35: The method of any of aspects 30 through 34, wherein the set of directional beams and the set of directional beam repetition patterns are associated with a set of sidelink SSB occasions, each sidelink SSB occasion of the set of sidelink SSB occasions includes a sub-occasion group of one or more sub-occasions, each sub-occasion of a given sub-occasion group is associated with a same directional beam, and different sub-occasion groups are associated with different directional beams.

Aspect 36: The method of any of aspects 30 through 35, further comprising: obtaining second sidelink information from the first UE, the second UE, or both; transmitting, to the first UE, the second sidelink information associated with the first UE, the second UE, or both; and receiving, from the first UE, an indication of a directional beam, wherein the directional beam is a prediction for a sidelink data message to be transmitted between the first UE and the second UE.

Aspect 37: The method of aspect 36, wherein the second sidelink information comprises a reference signal receive power associated with at least one of the set of sidelink SSBs, one or more receive beams and one or more receive beam repetition patterns used by the second UE, the first sidelink information, or any combination thereof.

Aspect 38: The method of any of aspects 30 through 37, further comprising: transmitting, to the second UE, an indication of the set of directional beams and the set of directional beam repetition patterns in accordance with the set of directional beams and the set of directional beam repetition patterns being the predictions for the set of sidelink SSBs to be transmitted between the first UE and the second UE.

Aspect 39: An apparatus for wireless communication at a first UE, comprising a processor; memory coupled with the processor; and instructions stored in the memory and executable by the processor to cause the apparatus to perform a method of any of aspects 1 through 19.

Aspect 40: An apparatus for wireless communication at a first UE, comprising at least one means for performing a method of any of aspects 1 through 19.

Aspect 41: A non-transitory computer-readable medium storing code for wireless communication at a first UE, the code comprising instructions executable by a processor to perform a method of any of aspects 1 through 19.

Aspect 42: An apparatus for wireless communications at a first UE, comprising a processor; memory coupled with the processor; and instructions stored in the memory and executable by the processor to cause the apparatus to perform a method of any of aspects 20 through 29.

Aspect 43: An apparatus for wireless communications at a first UE, comprising at least one means for performing a method of any of aspects 20 through 29.

Aspect 44: A non-transitory computer-readable medium storing code for wireless communications at a first UE, the code comprising instructions executable by a processor to perform a method of any of aspects 20 through 29.

Aspect 45: An apparatus for wireless communications at a network entity, comprising a processor; memory coupled with the processor; and instructions stored in the memory and executable by the processor to cause the apparatus to perform a method of any of aspects 30 through 38.

Aspect 46: An apparatus for wireless communications at a network entity, comprising at least one means for performing a method of any of aspects 30 through 38.

Aspect 47: A non-transitory computer-readable medium storing code for wireless communications at a network entity, the code comprising instructions executable by a processor to perform a method of any of aspects 30 through 38.

It should be noted that the methods described herein describe possible implementations, and that the operations and the steps may be rearranged or otherwise modified and that other implementations are possible. Further, aspects from two or more of the methods may be combined.

Although aspects of an LTE, LTE-A, LTE-A Pro, or NR system may be described for purposes of example, and LTE, LTE-A, LTE-A Pro, or NR terminology may be used in much of the description, the techniques described herein are applicable beyond LTE, LTE-A, LTE-A Pro, or NR networks. For example, the described techniques may be applicable to various other wireless communications systems such as Ultra Mobile Broadband (UMB), Institute of Electrical and Electronics Engineers (IEEE) 802.11 (Wi-Fi), IEEE 802.16 (WiMAX), IEEE 802.20, Flash-OFDM, as well as other systems and radio technologies not explicitly mentioned herein.

Information and signals described herein may be represented using any of a variety of different technologies and techniques. For example, data, instructions, commands, information, signals, bits, symbols, and chips that may be referenced throughout the description may be represented by voltages, currents, electromagnetic waves, magnetic fields or particles, optical fields or particles, or any combination thereof.

The various illustrative blocks and components described in connection with the disclosure herein may be implemented or performed using a general-purpose processor, a DSP, an ASIC, a CPU, an FPGA or other programmable logic device, discrete gate or transistor logic, discrete hardware components, or any combination thereof designed to perform the functions described herein. A general-purpose processor may be a microprocessor but, in the alternative, the processor may be any processor, controller, microcontroller, or state machine. A processor may also be implemented as any combination of computing devices (e.g., any combination of a DSP and a microprocessor, multiple microprocessors, one or more microprocessors in conjunction with a DSP core, or any other such configuration).

The functions described herein may be implemented using hardware, software executed by a processor, firmware, or any combination thereof. If implemented using software executed by a processor, the functions may be stored as or transmitted using one or more instructions or code of a computer-readable medium. Other examples and implementations are within the scope of the disclosure and appended claims. For example, due to the nature of software, functions described herein may be implemented using software executed by a processor, hardware, firmware, hardwiring, or combinations of any of these. Features implementing functions may also be physically located at various positions, including being distributed such that portions of functions are implemented at different physical locations.

Computer-readable media includes both non-transitory computer storage media and communication media including any medium that facilitates transfer of a computer program from one location to another. A non-transitory storage medium may be any available medium that may be accessed by a general-purpose or special-purpose computer. By way of example, and not limitation, non-transitory computer-readable media may include RAM, ROM, electrically erasable programmable ROM (EEPROM), flash memory, compact disk (CD) ROM or other optical disk storage, magnetic disk storage or other magnetic storage devices, or any other non-transitory medium that may be used to carry or store desired program code means in the form of instructions or data structures and that may be accessed by a general-purpose or special-purpose computer, or a general-purpose or special-purpose processor. Also, any connection is properly termed a computer-readable medium. For example, if the software is transmitted from a website, server, or other remote source using a coaxial cable, fiber optic cable, twisted pair, digital subscriber line (DSL), or wireless technologies such as infrared, radio, and microwave, then the coaxial cable, fiber optic cable, twisted pair, DSL, or wireless technologies such as infrared, radio, and microwave are included in the definition of computer-readable medium. Disk and disc, as used herein, include CD, laser disc, optical disc, digital versatile disc (DVD), floppy disk and Blu-ray disc. Disks may reproduce data magnetically, and discs may reproduce data optically using lasers. Combinations of the above are also included within the scope of computer-readable media.

As used herein, including in the claims, “or” as used in a list of items (e.g., a list of items prefaced by a phrase such as “at least one of” or “one or more of”) indicates an inclusive list such that, for example, a list of at least one of A, B, or C means A or B or C or AB or AC or BC or ABC (i.e., A and B and C). Also, as used herein, the phrase “based on” shall not be construed as a reference to a closed set of conditions. For example, an example step that is described as “based on condition A” may be based on both a condition A and a condition B without departing from the scope of the present disclosure. In other words, as used herein, the phrase “based on” shall be construed in the same manner as the phrase “based at least in part on.”

The term “determine” or “determining” encompasses a variety of actions and, therefore, “determining” can include calculating, computing, processing, deriving, investigating, looking up (such as via looking up in a table, a database or another data structure), ascertaining and the like. Also, “determining” can include receiving (e.g., receiving information), accessing (e.g., accessing data stored in memory) and the like. Also, “determining” can include resolving, obtaining, selecting, choosing, establishing, and other such similar actions.

In the appended figures, similar components or features may have the same reference label. Further, various components of the same type may be distinguished by following the reference label by a dash and a second label that distinguishes among the similar components. If just the first reference label is used in the specification, the description is applicable to any one of the similar components having the same first reference label irrespective of the second reference label, or other subsequent reference label.

The description set forth herein, in connection with the appended drawings, describes example configurations and does not represent all the examples that may be implemented or that are within the scope of the claims. The term “example” used herein means “serving as an example, instance, or illustration,” and not “preferred” or “advantageous over other examples.” The detailed description includes specific details for the purpose of providing an understanding of the described techniques. These techniques, however, may be practiced without these specific details. In some instances, known structures and devices are shown in block diagram form in order to avoid obscuring the concepts of the described examples.

The description herein is provided to enable a person having ordinary skill in the art to make or use the disclosure. Various modifications to the disclosure will be apparent to a person having ordinary skill in the art, and the generic principles defined herein may be applied to other variations without departing from the scope of the disclosure. Thus, the disclosure is not limited to the examples and designs described herein but is to be accorded the broadest scope consistent with the principles and novel features disclosed herein.

1. An apparatus for wireless communication at a first user equipment (UE), comprising:
at least one processor; and
at least one memory coupled with the at least one processor, with instructions stored in the at least one memory, the instructions being executable by the at least one processor, individually or in any combination, to cause the apparatus to:
receive, from a network entity, first sidelink information associated with the first UE, a second UE, or both;
predict, by the first UE based at least in part on the first sidelink information, a set of transmit beams and a set of transmit beam repetition patterns associated with a set of sidelink synchronization signal blocks; and
transmit, to the second UE, the set of sidelink synchronization signal blocks based at least in part on the set of transmit beams and the set of transmit beam repetition patterns.

2. The apparatus of claim 1, wherein the instructions to predict the set of transmit beams and the set of transmit beam repetition patterns associated with the set of sidelink synchronization signal blocks are executable by the at least one processor to cause the apparatus to:
input the first sidelink information into a model configured to predict one or more transmission characteristics associated with the set of sidelink synchronization signal blocks; and
obtain, from the model, the set of transmit beams and the set of transmit beam repetition patterns.

3. The apparatus of claim 1, wherein the instructions are further executable by the at least one processor to cause the apparatus to:
transmit, to the network entity, an indication of the set of transmit beams and the set of transmit beam repetition patterns.

4. The apparatus of claim 3, wherein the instructions to transmit the indication of the set of transmit beams and the set of transmit beam repetition patterns are executable by the at least one processor to cause the apparatus to:
transmit an identifier associated with the set of transmit beams and the set of transmit beam repetition patterns, wherein respective pairings of different sets of transmit beams and different sets of transmit beam repetition patterns are associated with a respective identifier of a set of identifiers.

5. The apparatus of claim 3, wherein the instructions are further executable by the at least one processor to cause the apparatus to:
receive, from the network entity, a request for the indication of the set of transmit beams and the set of transmit beam repetition patterns, wherein transmitting the indication of the set of transmit beams and the set of transmit beam repetition patterns is based at least in part on receiving the request.

6. The apparatus of claim 5, wherein the instructions are further executable by the at least one processor to cause the apparatus to:
transmit, to the network entity, a request to report the indication of the set of transmit beams and the set of transmit beam repetition patterns, wherein receiving the request for the indication of the set of transmit beams and the set of transmit beam repetition patterns is based at least in part on transmitting the request to report the indication of the set of transmit beams and the set of transmit beam repetition patterns.

7. The apparatus of claim 3, wherein the instructions are further executable by the at least one processor to cause the apparatus to:
receive, from the network entity, a confirmation of the set of transmit beams and the set of transmit beam repetition patterns, wherein transmitting the set of sidelink synchronization signal blocks comprises transmitting the set of sidelink synchronization signal blocks in accordance with the set of transmit beams and the set of transmit beam repetition patterns.

8. The apparatus of claim 3, wherein the instructions are further executable by the at least one processor to cause the apparatus to:
receive, from the network entity, an indication of an alternative set of transmit beams and an alternative set of transmit beam repetition patterns, wherein transmitting the set of sidelink synchronization signal blocks comprises transmitting the set of sidelink synchronization signal blocks in accordance with the alternative set of transmit beams and the alternative set of transmit beam repetition patterns.

9. The apparatus of claim 1, wherein the instructions are further executable by the at least one processor to cause the apparatus to:
transmit, to the network entity, a request for the first sidelink information, wherein receiving the first sidelink information is based at least in part on transmitting the request.

10. (canceled)

11. The apparatus of claim 1, wherein the set of transmit beams and the set of transmit beam repetition patterns are associated with a set of sidelink synchronization signal block occasions, wherein each sidelink synchronization signal block occasion of the set of sidelink synchronization signal block occasions includes a sub-occasion group of one or more sub-occasions, wherein each sub-occasion of a given sub-occasion group is associated with a same transmit beam, and wherein different sub-occasion groups are associated with different transmit beams.

12. The apparatus of claim 1, wherein the instructions are further executable by the at least one processor to cause the apparatus to:
receive, from the network entity, second sidelink information associated with the first UE, the second UE, or both;
predict, by the first UE based at least in part on the second sidelink information, a directional beam associated with a sidelink data message; and
communicate the sidelink data message with the second UE based at least in part on the directional beam.

13. (canceled)

14. The apparatus of claim 12, wherein the instructions are further executable by the at least one processor to cause the apparatus to:
transmit, to the network entity, an indication of the directional beam.

15. The apparatus of claim 14, wherein the instructions are further executable by the at least one processor to cause the apparatus to:
receive, from the network entity, a request for the indication of the directional beam, wherein communicating the indication of the directional beam is based at least in part on receiving the request.

16. The apparatus of claim 15, wherein the instructions are further executable by the at least one processor to cause the apparatus to:
transmit, to the network entity, a request to report the indication of the directional beam, wherein receiving the request for the indication of the directional beam is based at least in part on transmitting the request to report the indication of the directional beam.

17. The apparatus of claim 14, wherein the instructions are further executable by the at least one processor to cause the apparatus to:
receive, from the network entity, a confirmation of the directional beam, wherein communicating the sidelink data message comprises transmitting or receiving the sidelink data message using the directional beam.

18. The apparatus of claim 14, wherein the instructions are further executable by the at least one processor to cause the apparatus to:
receive, from the network entity, an indication of an alternative directional beam, wherein communicating the sidelink data message comprises transmitting or receiving the sidelink data message using the alternative directional beam.

19-29. (canceled)

30. An apparatus for wireless communications at a network entity, comprising:
at least one processor; and
at least one memory coupled with the at least one processor, with instructions stored in the at least one memory, the instructions being executable by the at least one processor, individually or in any combination, to cause the apparatus to:
obtain first sidelink information associated with a first user equipment (UE), a second UE, or both;
transmit, to the first UE, the first sidelink information associated with the first UE, the second UE, or both; and
receive, from the first UE, an indication of a set of directional beams and a set of directional beam repetition patterns based at least in part on the first sidelink information, wherein the indication of the set of directional beams and the set of directional beam repetition patterns is a prediction for a set of sidelink synchronization signal blocks to be transmitted between the first UE and the second UE.

31. The apparatus of claim 30, wherein the instructions to receive the indication of the set of directional beams and the set of directional beam repetition patterns are executable by the at least one processor to cause the apparatus to:
receive an identifier associated with the set of directional beams and the set of directional beam repetition patterns, wherein respective pairings of different sets of directional beams and different sets of directional beam repetition patterns are associated with a respective identifier of a set of identifiers.

32. The apparatus of claim 30, wherein the instructions are further executable by the at least one processor to cause the apparatus to:
transmit, to the first UE, a request for the indication of the set of directional beams and the set of directional beam repetition patterns, wherein receiving the indication of the set of directional beams and the set of directional beam repetition patterns is based at least in part on transmitting the request.

33-38. (canceled)

39. A method for wireless communication at a first user equipment (UE), comprising:
receiving, from a network entity, first sidelink information associated with the first UE, a second UE, or both;
predicting, by the first UE based at least in part on the first sidelink information, a set of transmit beams and a set of transmit beam repetition patterns associated with a set of sidelink synchronization signal blocks; and
transmitting, to the second UE, the set of sidelink synchronization signal blocks based at least in part on the set of transmit beams and the set of transmit beam repetition patterns.

40-76. (canceled)
